(19) United States
(12) Patent Application Publication
(10) Pub. No.: US 2023/0214398 A1
(43) Pub. Date: Jul. 6, 2023

(54) Data Privacy Management & Compliance Using Distributed Ledger Technology

(71) Applicants: Edmund A. Kazmierczak, Melbourne (AU); Steve O. Melnikoff, Lake Tapps, WA (US); David L. Ritter, Denver, CO (US)

(72) Inventors: Edmund A. Kazmierczak, Melbourne (AU); Steve O. Melnikoff, Lake Tapps, WA (US); David L. Ritter, Denver, CO (US)

(21) Appl. No.: 17/872,683

(22) Filed: Jul. 25, 2022

Related U.S. Application Data
(60) Provisional application No. 63/295,804, filed on Dec. 31, 2021.

(51) Int. Cl. G06F 16/2457; G06F 16/23

(52) U.S. Cl. CPC G06F 16/24573; G06F 16/24575; G06F 16/2365; G06F 16/2255

(57) ABSTRACT

Novel improvements in processes utilizing distributed ledger technologies for management and compliance with data privacy laws, regulations, policies, guidelines, rules, and standards of personal information. California Consumer Privacy Act (CCPA), together with similar Europe, Colorado and Virginia privacy laws, are exemplary applications. Metadata and database schemas are utilized to form one or more metamodels and data graphs, stored on a distributed ledger or blockchain. Apparatus, architectures and systems are also disclosed.

### CROSS REFERENCE TO RELATED APPLICATIONS

The present application claims priority in and to U.S. patent application 63/295,804 filed Dec. 31, 2021, and further is incorporated herein by reference.

### TECHNICAL FIELD

Embodiments pertain to novel improvements in processes utilizing distributed ledger technologies for management and compliance with data privacy laws of personal information. Apparatus, architectures and systems are also disclosed.

### BACKGROUND

Registering website accounts and purchasing goods online is an everyday activity in the era of high-speed Internet and digital commerce. Less common is awareness of how our personal information and transaction data is monetized by the tech industry, advertisers, e-commerce platforms, or other actors that interact with user data. Trading and selling of user data has become a highly lucrative business. This drives an associated demand for access to personal information, creating additional risk around how businesses and platforms handle privacy issues. Online businesses and social media platforms may be selling user data to third parties without first seeking consent and without disclosure to affected users.

At the same time, sophisticated hacking schemes are capable of breaching data systems at private companies and public institutions and stealing personal information about consumers, which is then sold for profit. The long list of consequences of failing to protect data privacy is now quite familiar: endless advertising pop-ups, robocalls, spam mail, phishing attacks, identity fraud, theft of financial assets, SIM switches, blackmail and ransom schemes, etc. In extreme cases, highly sensitive information about personal health and financial credit history have been stolen in data breaches at major corporations and sold with damaging and long-lasting consequences to consumers. This hurts not only the individuals who have their personal information stolen, but also the corporations that are the targets of data breaches, exposing them to legal liabilities, reputational harm, and possibly, punitive fines. The good news is that consumer advocates, industry leaders, and legislators are working together with communities on policies to protect personal information.

Pioneering legislative efforts, including Europe's General Data Protection Regulation (GDPR) and the California Consumer Privacy Act (CCPA), together with similar legislation in Colorado and Virginia and other states, are leading the way and changing how personal information fits into the landscape of digital commerce. Privacy regulations such as these will likely proliferate to other states and countries in the coming years, making privacy protection an increasingly important aspect of data systems management and Internet-based business.

The CCPA is a groundbreaking legislative effort to address online consumer privacy in the U.S., with wide-reaching implications for any organizations that collect and handle user data. Under the CCPA, businesses that collect consumer information have important disclosure and data management requirements to fulfill in order to show they are actively protecting consumer privacy. Although the CCPA law went into effect in January 2020, most businesses have not implemented effective compliance solutions to manage their data privacy concerns, and many lack the tools and technical know-how to do so.

Among the motivating factors behind the passage of CCPA is the need to curtail the dangerous proliferation of digital identity theft. A 2018 online Harris Poll found that approximately 60 million Americans were victims of identity theft, representing almost a four-fold increase from 2017. Javelin Strategy and Research found that annual US financial losses from identity theft in 2016 and 2017 ranged between $15-16 billion. Meanwhile, a string of data breaches at major financial and credit rating institutions have resulted in hackers gaining access to sensitive personal information for millions of Americans: 148 million Americans had their data breached at Equifax; 100 million impacted by an attack at Capitol One Bank; 76 million households impacted by a 2014 attack on JP Morgan.

Among the most sensitive and damaging articles of personal information stolen in identity theft schemes are Social Security numbers, which cannot be changed, leaving victims with serious problems to resolve. In many of the data breaches at big corporations, investigations revealed glaring cybersecurity lapses at the companies involved, as well as months of lag time in reporting data breaches to the public.

Privacy solutions must therefore not only address user privacy concerns but also public reporting requirements in the event that data breaches do occur. An important conclusion to draw here is that there are fundamental problems with the way organizations collect, process, manage, and store personal information about their customers, leaving consumer data vulnerable to hackers. Identity theft resulting from coordinated data breaches extends to the public sector as well, where there has been marked increase in data theft, and ransom attacks in the last few years.

In 2019, 22 government entities in Texas were hit by a coordinated cyberattack. The cites of Baltimore and Atlanta were also victims of recent cyberattacks, costing Baltimore an estimated $18 million in losses and Atlanta approximately $17 million in losses. Millions of people were affected by these attacks. Cyberattacks on public institutions and theft of private data related to city business have increased substantially in recent years, pointing to a lack of sufficient cybersecurity protections in data management systems hosted by local and state government institutions. Included in this is a lack of oversight and security related to data privacy for the citizens whose private records are stolen in such attacks.

Consumer privacy legislation, such as the CCPA, is pushing for greater visibility in data protection mechanisms, not just for private businesses, but also for public institutions. This is critically important, as data breaches at public institutions can result in identity theft and harm to consumers in the same way as data breaches at private companies. For purposes of the present disclosure, California's CCPA will be discussed and used as an exemplary embodiment, although embodiments of the present invention can be configured and applied to other state, federal or international laws, rules or regulatory structures with equal success.

Under the CCPA, businesses, regardless of their business geographic location, that collect customer data or personal information from individuals or households in California will have responsibilities to manage that information in accordance with the CCPA, and to report any usage of consumer data, including sale or transfer to third parties. The CCPA took effect on Jan. 1, 2020, and places limitations on the collection and sale of a consumer's personal information and provides consumers certain rights with respect to their personal information. The following paragraphs detail some of the key provisions in the CCPA, with a focus on understanding the challenges of how businesses must operationalize CCPA compliance.

1. Businesses Covered by CCPA. In general, the CCPA applies to a business or organization that:
(a) Does business in California;
(b) Collects personal information;
(c) Makes decisions about processing collected data; and
(d) Satisfies at least one of the following:
   (i) Annual gross revenue in excess of $25 million;
   (ii) Buys, receives for commercial purposes, sells, or shares for commercial purposes, the personal information of at least 50,000 consumers, households, or devices; or
   (iii) Derives at least 50 percent of its annual revenues from selling consumers' personal information.
(e) A business under CCPA also includes any entity that controls or is controlled by a business that meets the requirements above.
(f) A business need not be located in California to be subject to the CCPA. A business may be “doing business” in California if it conducts online transactions with persons who reside in California may be required to comply with CCPA.

2. Personal Information Under CCPA. The CCPA provides a non-exhaustive list of categories of personal information, including:
(a) Personal identity information, including name, postal address, Internet protocol (IP) address, email address, account name, social security number, driver's license number, passport number, or other identifying information;
(b) Characteristics of protected classifications under California or federal law;
(c) Commercial information, including records of personal property, products, or services purchased, obtained, or considered, or other purchasing or consuming histories or tendencies;
(d) Biometric information;
(e) Internet or network activity information, including, but not limited to, browsing history, search history, and information regarding a consumer's interaction with an Internet website, application, or advertisement;
(f) Geolocation data;
(g) Audio, electronic, visual, thermal, olfactory, or similar information;
(h) Professional or employment-related information;
(i) Education information, defined as information that is not publicly available personally identifiable information as defined in the Family Educational Rights and Privacy Act (FERPA).
(j) Payment information, credit card numbers, purchase history, etc.

3. Consumer Rights Under CCPA. The CCPA addresses a number of consumer rights which are protected under the statute, including:
(a) Notice: businesses collected PI must inform consumers at or before the time of collection.
(b) Access & Information: Consumers under the CCPA have the right to request information regarding what personal information has been collected, whether that information has been shared with third parties, who those third parties are, the specific purpose and reason that personal information was collected, and more.
(c) Deletion: With some exceptions, the CCPA permits consumers to request that covered businesses, and their direct service providers, to delete personal information collected about them.
(d) Opt Out: Under the CCPA, consumers are empowered to opt out of the sale of their personal information. To facilitate consumers exercise of this right, covered businesses must provide a “Do Not Sell My Personal Information” link on the business's Internet homepage, as well as other Opt-Out mechanisms.
(e) Non-Discriminatory: The CCPA prohibits covered businesses from discriminating against consumers for exercising their CCPA rights. Consumers can neither be denied business, services, nor required to pay different prices due to exercising CCPA rights.
(f) Verifying & Handling Consumer Requests: Under CCPA, businesses must respond to consumer CCPA requests and must demonstrate compliance with requests such as deletion or requests for access and information.

Given the above, there are a number of key compliance requirements for business to be compliant with the CCPA.
[symbol] Requirement #1: Compliant Data Inventory & Management. Businesses must first implement a robust data inventory management system to fulfill their data tracking, archiving, and reporting requirements under CCPA. The data inventory management system must also be private and secure so as to prevent itself from being the cause of a breach of personal information.
[symbol] Requirement #2: “Operationalize” Consumer Rights Request Processes. The CCPA has strict requirements for how to handle consumer data privacy rights requests. It is important for compliance to not only implement workflow processes that satisfy the basic handling of consumer requests, but also to document and archive the handling of such requests. Thus, operationalizing consumer requests is tied to both businesses workflow processes and data workflow processes, together forming essential parts of an organization's CCPA compliance record.
Requirement #3: Implement User Consent (Opt-In/Opt-Out Provisions). User consent provisions, such as opt-in and opt-out provisions, and their implementation mechanisms differ depending on the whether the consumer is a minor or an adult. There are a number of mechanisms that must be considered as part of User Consent implementation, and, as with operationalizing consent implementation, these must become part of the data record for each consumer and tracked against future rights requests or inquiries of data usage.
Requirement #4: Manage Vendor Data Requests. For businesses that rely upon on data-driven workflow services through third party vendors, the onus of documenting and disclosing any sale and/or transfer of consumer data to them falls upon the business collecting consumer information. Vendor data requests must be tracked closely to ensure adherence with CCPA disclosure requirements.
Requirement #5: Interdepartmental/Interoffice Collaborations. The CCPA compliance requirements extend to affiliate offices, offices outside of California doing business with California consumers, and multiple departments within the same business. To comply, businesses are responsible for tracking consumer information as it passes through intra-organization workflow processes to ensure appropriate disclosure, record keeping, and consent management.
Requirement #6: 12 Month “Look-back” Provision. The CCPA imposes a 12-month “look-back” from the time of the request and mandates that, if consumers request access to their personal information, the covered business provide responsive materials “in a readily usable format that allows consumers to transmit information from one entity to another without hindrance.”

For both California and non-California businesses and organizations, re-architecting their data systems to fulfill these demanding requirements is a time-consuming and costly prospect. In fact, most businesses have not been able to do so, and remain in non-compliance.

Other states such as Colorado and Virginia have also been enacting their own privacy laws in a similar manner. Unfortunately, from state to state there can be further differences in specific terms and mandates, which further compounds the problems for businesses conducting business in multiple states.

For the reasons above, the business environment for those that operate in commercialization of user data or personal information becomes a minefield to navigate. What is needed in the present environment is a different approach for businesses to manage their user data, meet the requirements detailed above and ensure compliance with privacy laws.

### SUMMARY

The preferred embodiments disclosed herein address and help a company or user implement compliance, in a preferably transparent, distributed manner compliant with consumer privacy laws, rules, regulations, guidelines, policies, principles or standards. More particularly, preferred embodiments implement, automate, audit, and demonstrate compliance with consumer rights processes with robust and reliable reporting tools and do not require a business to retrofit nor re-work their internal user data processes.

Embodiments are designed to be a turnkey, cost effective solution to help businesses comply with consumer privacy laws, guidelines, policies and regulations, in the United States and other countries with similar regulatory policies. For purposes of the present disclosure, California's CCPA will be discussed and used as an exemplary embodiment, although embodiments of the present invention can be configured and applied to other state, federal or international laws, rules or regulatory structures with equal success.

Embodiments enable businesses and online platforms to deploy a simple to use toolkit that addresses the data management, consumer request tracking, disclosures, and reporting requirements of the CCPA and other consumer privacy laws, regulations, policies, rules, and regulatory standards. Rather than incurring significant expense to reengineer complex data systems, embodiments strategically apply distributed ledger technology (DLT) to existing systems. Harnessing the power of DLT, the embodiments offer both privacy and transparency features crucial to the data systems underpinning businesses and online platforms.

One aspect of preferred embodiments of the present invention is eliminating costly expenses for compliance that arise from trying to re-engineer complex IT data systems. Preferred embodiments of the present invention preferably operate without interference, re-engineering or modification to the complex IT data systems already in place. This creates a traceable, auditable, and verifiable infrastructure for data inventory management, which can be used for implementing compliance solutions.

Various embodiments of the present disclosure represent a significant advancement in management of user data. In particular, preferred embodiments can perform privacy compliance automation without storing or collecting a subject business's data. The various methods and apparatus described can also be implemented in medium, memory and system forms.

### BRIEF DESCRIPTION OF THE DRAWINGS

Embodiments are illustrated by way of example, and not by way of limitation, in the figures of the accompanying drawings and in which like reference numerals refer to similar elements.

FIG. 1 is a prior art Venn diagram illustrating various contexts of business data.

FIG. 2 is a logical diagram illustrating metadata and personal information within vendor databases.

FIG. 3 is a logical diagram contrasting metadata and personal information within vendor databases.

FIG. 4 is a logical diagram illustrating a prior art embodiment transmitting personal information through a firewall.

FIG. 5 is a logical diagram illustrating an embodiment of the present invention transmitting metadata through a firewall.

FIG. 6 is a logical diagram illustrating an embodiment for personal information management.

FIG. 7 is a flowchart illustrating an embodiment for extraction of metadata, creation of a metamodel, and storage of the metamodel on a distributed ledger.

FIG. 8 is a logical diagram illustrating an embodiment for personal information management.

FIG. 9 is a logical diagram of an embodiment for administration of a consumer request.

FIG. 10 is a flowchart illustrating an embodiment for administration of a consumer request.

FIGS. 11a and 11b are logical diagrams illustrating a database table.

FIGS. 12a and 12b are logical diagrams illustrating a primary key and related attributes.

FIGS. 13 and 14 are logical diagrams illustrating an embodiment for personal information management.

FIG. 15 is a logical diagram illustrating a computer implementation.

### DETAILED DESCRIPTION OF PREFERRED EMBODIMENTS

In the following description, for the purposes of explanation, specific details are set forth in order to provide a thorough understanding. However, it will be apparent that embodiments can be practiced without these specific details. In other instances, well-known structures and devices are depicted in block diagram form in order to avoid unnecessary detail relating to the corresponding discussion; and similarly, steps in the disclosed method are depicted in flow diagram form. Section titles and references appearing within the following paragraphs are intended for the convenience of the reader and should not be interpreted to restrict the scope of the information presented at any given location.

The unique experiences and enhancements described herein comprise a plurality of advancements within various scopes in the business and technological arts. As such, each of the respective groupings of advancements and enhancements are described in more detail hereinafter in sections, which shall not be considered limiting in nature.

### INTRODUCTION

Embodiments of the present invention comprise a comprehensive data privacy management toolkit and solution based on distributed ledger technology (DLT), and in preferred embodiments, more specifically blockchain technology.

Embodiments enable businesses to implement compliance solutions in their existing data systems for various federal, state and international privacy laws, regulations, policies, rules, and regulatory standards. Although the California Consumer Privacy Act (CCPA) is utilized in this disclosure as an exemplary application, other privacy laws in domestic or foreign jurisdictions can equally be utilized by embodiments of the present invention.

Preferred embodiments herein demonstrate a focus on data inventory management, tracking consumer rights request processes, and auditing and reporting functions. Embodiments are the first distributed ledger or blockchain-based solution in the market to address data privacy management for businesses under CCPA (or any other consumer privacy laws, regulations, policies, rules, and regulatory standards).

More particularly, embodiments of the present invention exhibit a process, an apparatus or a system to store, track, manage, verify the status of an individual's private data, track individual's requests and to operationalize the compliance requirements of data privacy laws and regulations. In preferred embodiments, this is performed in a way that does not require any private data, or any individual's private data, to be uploaded or stored in order to track, manage, verify or operationalize privacy compliance activities.

Other aspects of preferred embodiments of the invention incorporate a “metamodel” or “metamodel data graph” to capture and operationalize data privacy compliance without the need for collecting, transferring, or storing business data or business customer's private details outside of the business's data systems.

### Definitions

For purposes of the present disclosure, the following definitions are adopted. The definitions that follow, or throughout this document, are not limiting in nature, but used by way of example to help teach a person of reasonable skill in the art to practice the invention.

“Consumer”, “customer”, “individual” and “user” may be used interchangeably in the disclosure herein.

“Personal information”, “personal data”, “private information”, “private data” and “user data” (and similar terms with these words) may be used interchangeably and are directed toward information that identifies, relates to, or could reasonably be linked with with an individual or an individual's household. For example, it could include an individual's name, social security number, email address, records of products purchased, internet browsing history, geolocation data, fingerprints, and inferences from other personal information that could create a profile about your preferences and characteristics. It may also include information or data that that is stored about an individual or consumer affiliations, habits, status, possessions, interactions or other information that they do not wish to be made public, or that is not to be made public by law or by policy of the organization that holds their data.

“Data harvesting” or “data wrangling” is the process of cleaning, structuring and enriching raw data into a desired format for better application use. With respect to embodiments herein, this is part of the process for metamodel creation.

A “distributed ledger of record” or “distributed ledger” is a digital data store that is typically replicated, shared, and synchronized, preferably geographically distributed across multiple physical sites with no central administration. Distributed ledgers use independent computers (referred to as nodes) to record, share and synchronize transactions in their respective electronic ledgers (instead of keeping data centralized as in a traditional ledger). A “blockchain” is one form of a distributed ledger but distributed ledgers may also include special types of synchronized distributed databases. Blockchain organizes data into blocks, which are chained together in an append only mode. Distributed ledgers and blockchains commonly use cryptographic protocols to ensure data integrity and consensus mechanisms to ensure data congruity.

A “data graph” or “graph” is a mathematical entity defined to be a set of “vertices” and a set of “edges” relating vertices to one another. Alternatively, data graph edges may also be called “relationships” or “connections.” A “metamodel data graph” is a data graph containing at least one metamodel but may be a collection of individual metamodels. A “Connected Component” in a data graph is a set of vertices in which every pair of edges is connected by a sequence of edges.

A “table” refers to a table or relation in SQL databases, as well as collections in NoSQL databases.

### Diverse Data

Tracking personal information in a single database with a single data model is relatively straightforward (provided system administrators demonstrate compliance with consumer requests). However, businesses today usually run multiple databases, employ commercial customer relations management (CRM) tools and subscribe to customer data analytics sites.

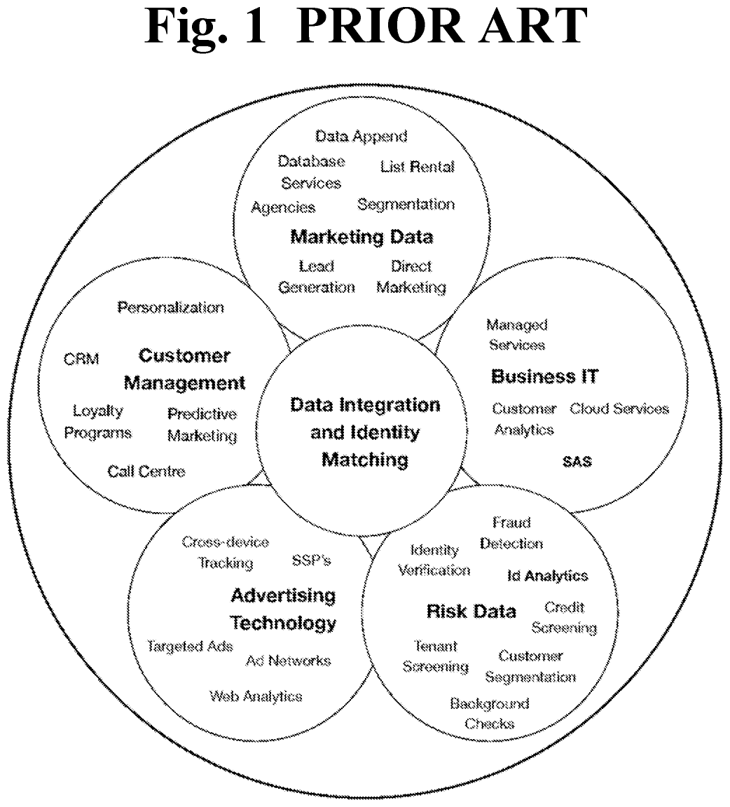

In FIG. 1, various contexts of proprietary and user data within a business are illustrated. All of these contexts increase the complexity of a business's data ecosystem, reinforcing the need for a robust data inventory management and data tracking tool.

Data entering a business' data ecosystem can be either temporary, or persistent. Temporary data can either be stored for a short period of time or simply collected on behalf of an external third party. Temporary data may be stored informally in files, spreadsheets or CSV files, or more formally in databases and formally organized file systems.

Persistent data is usually stored formally in databases using one of a growing number of database management systems or formally in structured file systems like IPFS.

Data is also manifest in accounting, ERP and CRM systems where the data is still stored formally in databases of managed filesystems but is less accessible because of the intervening accounting, ERP or CRM software.

### Personal Information Vs Metadata

Personal information contains information, such as a person's name, address, phone number, email address, etc.—information which is specific to an individual. However, “metadata” is additional data describing or having attributes about the personal information, but not the personal information itself. Metadata may be a field name in a data scheme, an identifier, size, parameter or other attribute.

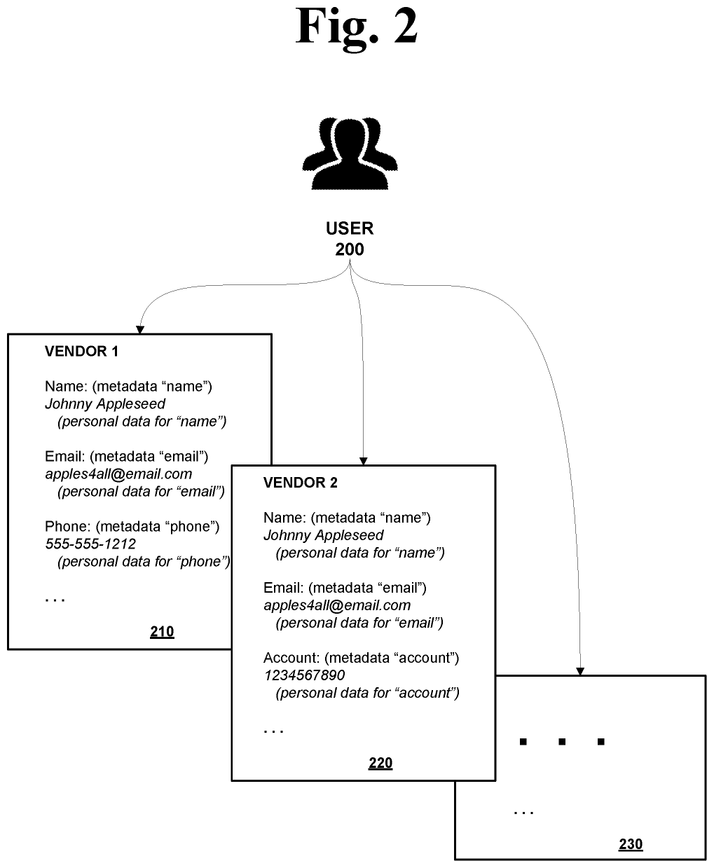

FIG. 2 illustrates the difference between personal information and metadata given a user 200. By way of example, within a Vendor 1's database is a record 210, a person's name may be “Johnny Appleseed”. However, the metadata for this data field may be “name.” Thus, metadata (e.g. name) can be associated with identifying the type of data, whereas the value of the metadata or data itself would be personal information (e.g. Johnny Appleseed).

Another example would be the email address and phone number of the person. Respectively, the metadata could be regarded as “email” and “phone”, which does not divulge any specific email address or specific phone number. Accordingly, the personal information for these metadata fields may be specific values for Johnny Appleseed, such as “apples4all@email.com” and “555-555-1212.”

Examples of Johnny Appleseed's metadata and personal information may appear in other records such as a record 220 from a Vendor 2 database, or in other records 230 from other vendor databases.

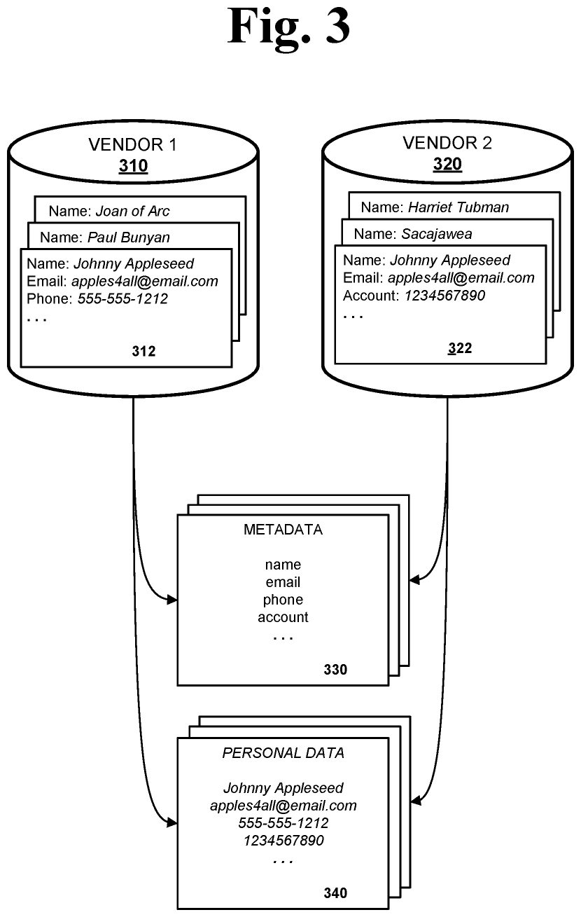

Turning to FIG. 3, a vendor database 310 and a vendor database 320 are illustrated with personal information record 312 and data record 314, respectively, for an individual named “Johnny Appleseed.” As shown, a metadata 330 identifies the data fields of the data records 312 and 314, such as name, email, phone and account. The private data to this metadata 330 (e.g. data fields) are illustrated in the personal information 340.

A breach in personal information 340 is clearly a serious problem as a name, email address, phone number or account number of a person or personal information record may have been compromised. However, a breach of metadata on the other hand, is rather benign as no personal information about a person is compromised, other than the notion that the data record may have a name, email address, phone number or account number.

For these reasons, working with metadata 330 when managing personal information is advantageous over working with personal information 340.

### Basic Architecture

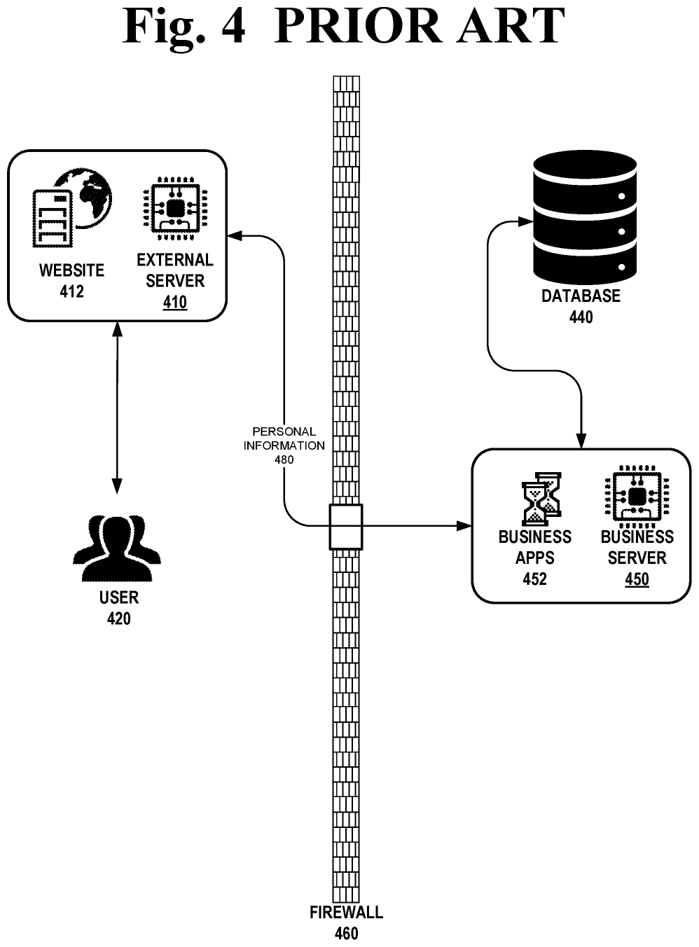

Turning to FIG. 4, a prior art solution is illustrated. More particularly, a user 420 communicates with a website 412 hosted on an external server 410 regarding personal information 480. The external server 410 communicates with one or more business apps 452 hosted on a business server 450, which interacts with a database 440.

It is noted that personal information 480 is communicated through a firewall 460 between the external server 410 and the business server 450. Such communications must be substantially sophisticated, and thus vulnerable to attack, based on the fact personal information 480 is being transmitted back and forth through the firewall.

Due to the inherent transmission of personal information 480, regardless of the sophistication and robust nature of the firewall 460, the personal information 480 is at a higher risk of compromise and breach, compared to embodiments of the present invention, where no personal information passes through a firewall.

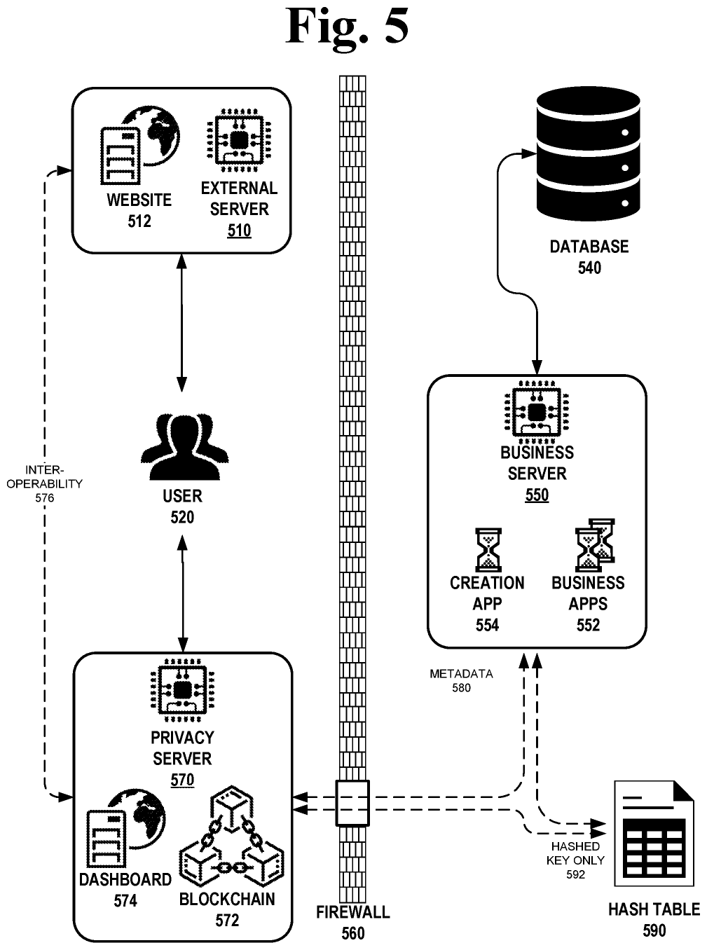

Turning to FIG. 5, such an embodiment of the present invention is illustrated. More particularly, a user 520 communicates with a website 512 hosted on an external server 510 regarding personal information, similar to FIG. 4. The external server 510, however, does not need to communicate with business apps 552 hosted on a business server 550, which interacts with a privacy server 570 via interoperability 576 (e.g. a link, connection or other communication means). Thus, the website 512 can pass the user to a privacy server 570 implementing a distributed ledger or blockchain 572.

The blockchain 572 hosted by the privacy server 570, instead, contains encrypted metadata (not shown) necessary for the user 520 to manage their personal information via metadata only (metadata previously setup on the blockchain 572 by a creation app 554 hosted on the business server 550).

It may be necessary for the privacy server 570 to communicate with a hash table 590 located on the other side of the firewall 560. For example, this may be necessary for a user 520 or the privacy server 570 to lookup a hashed key 592 in the hash table 590. In such occasions, only a hashed key 592 or metadata 580 passes through the firewall 560.

By and through this diversification of personal information from metadata, only hashed key 582 or metadata 580 pass through a firewall 560, and personal information does not pass through the firewall 560.

In this regard, embodiments as illustrated in FIG. 5 are substantially less vulnerable to compromise and breach, as no personal information is transmitted through the firewall 560.

### Blockchains

For a deeper analysis of embodiments of the present invention, a deeper understanding of distributed ledgers and blockchains is helpful.

Blockchain is a form of distributed ledger technology (DLT). At its core, blockchain and other DLTs are encrypted tools that are highly effective in tracking digital processes, managing accounting records and transaction history, and providing tools for implementing data security and privacy protections. Blockchain technology provides critical digital infrastructure for information systems that wish to achieve trusted data and trusted workflow outputs.

As relates to privacy protections in data systems, distributed ledger technology is an ideal technology for automating the processes related to data inventory management, tracking consumer requests and changes to privacy preferences, demonstrating privacy compliance activities through auditing capabilities, and generating reports that provide visibility into data activities.

Privacy problems arise when user data or metadata is taken from data systems and sent to third party processors without the user's consent. Blockchain technology makes it possible to automate data inventory management and the tracking of data flows on a verifiable and auditable ledger.

Automation in data tracking can then be used to automate reporting processes, such as may be required to satisfy CCPA or other regulatory reporting requirements. Enforcement of privacy laws like CCPA will likely center on the ability of a business to demonstrate compliance, reinforcing the importance of robust data inventory management and tracking mechanisms, such as those offered by embodiments herein.

### Modern Data Ecosystem

Modern data ecosystems provide companies with the tools to create better services for their customers and more personalized user experiences. Those same systems, however, can also enable tools and functions (like AI and machine learning tools) that generate highly comprehensive statistical models detailing a person's habits. A data record constructed from different data sources can include hundreds of different items: data that identifies the individual, demographic data, social media data, Internet browsing history, home and neighborhood data, memberships of clubs and societies, shopping preferences, political activities and affiliations, vehicles, travel, health, and more.

The CCPA and Europe's General Data Protection Regulation (GDPR) set forth regulatory frameworks to determine what kind of information can be collected and what businesses are allowed to do with that information. The CCPA and GDPR promote a vision of data usage by businesses that balances the role of data collection in e-commerce with the need to protect the privacy of individuals who are part of the ecosystem.

### Privacy and Security

Privacy shares a number of similarities with security. While there is overlap between the two, privacy is a different concern to security in data systems, and typically requires different software applications to implement. Having a security policy in place for digital systems is necessary to protect data but it does not guarantee data privacy. Moreover, data security mechanisms do not offer compliance with the CCPA's data privacy requirements. Three core aspects of cyber security are Confidentiality, Integrity and Availability.

Confidentiality refers to protecting sensitive information from unauthorized access. Confidentiality ensures that the things that we want to keep secret, stay secret. Aspects of privacy are similar in that digital privacy is concerned with the ability of individuals to securely and freely use the Internet without fear of losing control over who has their personal information and how it is used. But while data security may restrict the ability of non-authorized users to access confidential data, it does not explicitly protect personal information. There are a number of methods that serve to assure confidentiality in security systems. Many of these methods also contribute to protect privacy, and a partial list includes the following:
(a) Encrypting sensitive files and communications—encryption renders data unreadable to anyone except those who have the correct password or cryptographic key. It also provides a certain amount of control over access to data, because anyone not having the right cryptographic keys will not be granted access.
(b) Managing data access—managed data access assures that access is only authorized and granted to individuals who have a “need to know” eligibility.
(c) Physically secure devices and paper documents—this includes controlling access to both the digital and physical data repositories. Many businesses have duplicates and redundancies in their data storage protocols. This presents an example of how data security and privacy may diverge at times, as duplicated data files protect the security of data continuity, but at the same time they create a second target hackers may seek to breach.
(d) Secure disposal of data, devices, and paper records—disposal or data deletion occurs when a set data is no longer required or needed. This is effective in both data security and privacy (however for CCPA compliance deletion of consumer information must be demonstrated).
(e) Managing data acquisition and utilization—businesses can enhance security by only collecting and storing sensitive data that is needed, and only using it for expressly defined purposes.
(f) Managing all attached devices—this is to ensure any device that downloads secure and private data does so on a device that encrypts sensitive files and manages data access properly. If hardware devices are used to collect consumer information, additional privacy concerns come into consideration, and the definition of the data ecosystem for that business needs to encompass any location where PI resides.

Integrity is the assurance that the data a business holds is accurate and consistent over the entire lifecycle of that data. Data integrity is concerned with assuring authenticity and protecting authentic data from improper maintenance, modification, or alteration.

Availability ensures access and usability whenever data needs to be accessed and utilized. A typical threat to availability is a “Denial of Service” attack. For embodiments of the present invention, the concern around data availability is not primarily about a denial of service, but more about unwanted interruption of users' online engagement. Technology that assures continuity in online engagement, however, should not sacrifice data privacy for those users.

Combining confidentiality with integrity ensures confidence that customers' personal information in databases is authentic and only available to those authorized to access that data. Confidentiality goes a long way to protecting the security data and communications. It also helps with protecting data privacy, but not in all aspects.

### Scenarios where Data Security does not Cover Data Privacy

Security techniques focus on keeping data safe, by protecting data from unauthorized access when data is being stored or communicated. But it does not take into account the following two scenarios, which point to privacy considerations:
(a) When data is acquired in partnership with another organization. For example, when a business uses Google Analytics or other web analytics providers to analyze collected consumer data. In this case the business no longer has complete control over their customers' data because it now shares that data with the analytics organization. Under consumer privacy laws and regulations, this case scenario could be understood as a collector-processor arrangement, or a “vendor” arrangement.
(b) A business legitimately shares or sells data to another business. In this case, from a security perspective there is no unauthorized access and the business has not breached confidentiality.

However, there are data privacy concerns that should be addressed to protect customers' personal information once it has been passed to the second business. In both cases, a business sharing personal information must be able to track the information it has shared with other parties. But this scenario is not covered by most security methods involving confidentiality.

Rather, a data privacy solution would be needed to track and audit data proliferation in these scenarios. When a consumer submits a verified request to view or delete personal information, a business must be able to comply with that request. Compliance here involves isolating every instance of that consumer's personal information in the business's data systems, and reporting to the consumer that the request has been fulfilled.

Moreover, under CCPA it is not enough to process a consumer request, the business must demonstrate compliance. Companies of any size might invest in customer behavior analysis tools like Google Analytics, Mixpanel, KISSmetrics or Clicky. They are also likely to have a number of SQL or noSQL databases (including Oracle, MongoDB or CouchDB), and to use CRM tools similar to Hubspot, Streak or Zoho. Usage of any of these tools create situations in which data privacy may be vulnerable to breach.

To fulfill a consumer request or to review data usage or to delete consumer data, a business must be able to provide an audit trail showing compliance. Cyber security tools are inadequate to achieve this, and privacy focused software, such as embodiments presently disclosed, are required.

### Data Inventory Management Using Distributed Ledgers of Record

Distributed ledgers or blockchains coupled with the tools that aggregate metadata from databases can be appropriated for the task of data inventory management. Blockchains are distributed ledgers of record, where copies of the ledger reside on many different computers (“nodes”). When a data entry (such as a “transaction”) onto one of the distributed ledgers is made, all the nodes then cross-communicate to achieve a “consensus” about the validity of the new transaction and then each node individually copies (“writes”) it onto the local distributed ledger of record.

If any of the nodes are lost or become unavailable, the remaining nodes continue to function normally as a distributed community. Sets of transactions are grouped together into a single data structure called a “block”. Next, blocks accepted onto the distributed ledger or blockchain are each hashed and the resulting digital signature (“hash signature” or “signature”) is also stored.

The signature is stored separate to the originating block. It is preferable that all hash signatures are written into a block subsequent to the one from which they derive. Thus, tampering with any bit of the data on a distributed ledger or blockchain can be easily discovered because any change invalidates that block's signature. This process makes distributed ledgers or blockchains immutable and tamper-proof, because as a ledger increases in length (the number of blocks) each entry effectively protects the previous, forming an “immutable chain of data blocks” (e.g. a “blockchain”).

In this way, distributed ledgers and blockchains are an effective technology for managing data inventory, because they implement data integrity and availability at minimal additional resources. Distributed ledgers and blockchains are digital accounting tools, and therefore offer exactly the kind of underlying architecture and functionality required to implement data privacy tracking and monitoring. Whenever a database insert, update, or deletion event occurs for a customer, the metadata for that transaction is logged against the customer's account on the distributed ledger or blockchain.

### Provisioning Data Inventory Management

Implementing data inventory management on the distributed ledger or blockchain is a multi-step process, with several fundamental steps comprising: (1) baselining the data that is collected; (2) creating the data assets on the distributed ledger; and, (3) putting in place processes to update the data assets whenever the data acquired by the business changes.

Step 1: Baselining Data to be Collected. Ideally data collection should be as automated as possible and not interfere with the data itself. For data inventory management, the personal information is not required, but rather the metadata describing the personal information including: what logical data fields are being stored, whether or not the data identifies individuals, which data fields are related to a consumer's personal information, and whether or not particular data fields are generated locally within an organization or supplied by an external vendor. The first step in baselining of data is to extract relevant metadata from the databases. In SQL databases, the physical data schema provides the names of the fields for each (database) table, table keys and their data types. Annotation of any fields that possibly convey personal information might be needed as part of the baselining process. The metadata required would usually be located in the logical and the physical database schemas for many well-known SQL databases such as Oracle, Postgres and MySQL, and also available for many No-SQL (document) databases like MongoDB.

Step 2: Creating Distributed Ledger Data Assets. A data asset for a consumer consists of: (a) the consumer's digital business identity; and (b) metadata associated with the data for their registration, onboarding and initial selection of products. Metadata is derived from the database schemas, collections and other sources where the consumer's personal information is stored. A source can be an organization's data repository or it can be a third party collecting data on behalf of the organization. To create data assets we first create a metamodel of the organization's databases. Intuitively, the metamodel data graph is a data graph where the vertices of the data graph are the tables of an SQL database or the collections of a document database. An edge between two vertices exists if a field containing personal information is linked via a database key, either explicitly or implicitly, to another table or collection containing additional data related to the consumer. If the data repository for the organization was purely an SQL database with multiple tables then our metamodel would resemble the data graph topology of an Entity-Relationship diagram, but document databases and other forms of data storage are included in our metamodel. The natural auditing capabilities of the embodiment's distributed ledger or blockchain architecture offer a valuable service to businesses interested in implementing privacy solutions and compliance with CCPA and other privacy laws, regulations, policies, rules, guidelines, and standards.

Step 3: Updating Data Assets. Any actions that can affect the structure of a data collection trigger updates to the metamodel and subsequently to the metadata collected for an individual consumer. Because the metadata stored for an individual on the distributed ledger or blockchain is immutable, any changes to the structure of that metadata must be done using distributed ledger or blockchain transactions. Further, any changes or action on the personal information are recorded on the distributed ledger or blockchain as operations linked to metadata. Changes to the structure of the metadata and operations linked to metadata appear on the ledger of record. In effect, in preferred embodiments, changing either the underlying data or metadata of an enterprise database is automatically tracked by the distributed ledger or blockchain, leaving a “trusted” audit trail. Automating the data privacy audit trail embodiments herein offers great resource savings to businesses.

### Metamodels

“Metamodels” as defined in O'Reilly's Model-Driven Software Development, are models that make statements about modelling. In the case of embodiments herein, a “metamodel” is used to capture the underlying architecture of a data management system (e.g. its schema or identifier of data) without disclosing any of the personal information. Properties can be attached to the metamodel. In the case of preferred embodiments each field contained in a metamodel also has a public/private attribute, referred to as a “privacy setting.”

Embodiments of the present invention incorporate a metamodel. In preferred embodiments of the present invention, a metamodel is a special type of vehicle that contains metadata for a given person or entity, also carrying privacy vertices and edges/connections that represent metadata (e.g. presence of personal information in other databases) and privacy relationships. The metamodel is a single mathematical/computational model that captures the data architecture of a business across all of its different databases, different database systems and across different vendor organizations.

The customers of a business are, in effect, each assigned a metamodel to track the privacy status of their individual data across all of the business' databases, database systems and vendor organizations with whom the business shares data. The metamodel is a block within a distributed ledger, for the business' data management, customer privacy tracking, reporting, verification.

The current implementation implements the metamodel as a distributed ledger using a conventional blockchain. The transactions of the conventional blockchain are used to implement the operations on the metamodel.

Given the above process, there are unique aspects about embodiments of the present invention that should be considered. In steps 1 and 2 above, a source data system containing private data of individuals is mapped and a metamodel of the client's data systems is created. The metamodel is created purely from metadata from the databases, filesystems and spreadsheets and does not use any individual's personal information from the databases, files or spreadsheets. The process described above is executed on the source data system to map the data and the resulting metamodel is uploaded and stored in a distributed ledger.

In a preferred embodiment, the metamodel can be a “mercerized data graph” together with a set of connected components. This data graph and its connected components relates data from one store that is private with data in another store, that may not itself be private, but is made private by association with data in the first store.

In the language of data graphs if there is an edge E between vertices v₁ and v₂ and v₁ contains private data then v₂ also contains private data by being associated with v₁ through the edge E. The connected component consists of all those vertices that are associated to private data and each other.

The metamodel is created from a database's logical schema and not from the data values themselves. Likewise, the metamodel is created from file system names and not from the contents of files.

The metamodel is completed by assigning a vector of attributes to the vertices of the metamodel. The attributes specify whether or not the vertex contains private data, the source of the data (whether it is from an external source such as a vendor or if it is locally sourced), whether or not the data has been shared and the state or jurisdiction in which the data is located.

We use the term “meta” in this context, and refer to our model as a ‘metamodel’ because it is a model about the personal information and not a model from the personal information.

The status of each business customer's data as held by the business is tracked against the metamodel acquired in step one. The protocol does this by anonym izing the business customer's key data by hashing that data and just using the hash perform tracking functions. The business customer's data remains with the business while only the hash is used to identify the customer in the distributed ledger.

Each business customer's hash is associated with the connected components of the metamodel that contain their personal information. In the current embodiment this is done by assigning a copy of the metamodel with the attributes for each vertex assigned values reflecting the business customer's data privacy status and preferences.

Each operation on a business customer's data (creating a new metamodel, updating their metamodel, generating a report, etc.) creates a transaction on the distributed ledger. In the current embodiment the operations on a business customer's metamodel are transactions on a distributed ledger or blockchain.

### Building a Metamodel Data Graph

Embodiments of the present invention map an enterprise (e.g. business) database system architecture into an encrypted distributed ledger, without revealing any personal or proprietary information. While preferred embodiments disclosed herein may focus by way of example on California Consumer Privacy Act (CCPA), other privacy laws, regulations, policies, guidelines, regulatory standards or business motivations may be utilized.

Embodiments preferably utilize a “push” model for all data transfers, so that information control is always possessed, retained and under full control by the business. This feature is unique to embodiments disclosed herein, in view of prior art. It is key to ensuring, without compromise, enterprise control of their customers' data.

As noted earlier, the process takes place in multiple stages. The first stage is to locally map a business's databases and data systems to the distributed ledger services. This map is referred to as the metamodel data graph and contains one or more metamodels. Proprietary software scans a business' data sources, linking together the underlying architecture in a discovery process as to what data fields have been collected by the enterprise, and on which systems the collected data resides. Each metamodel is saved by the enterprise on their local systems.

The second stage is to generate a second mapping in the form of a lookup table that contains fields from the customer databases and a hash value. The fields from the customer databases act as primary keys into the customers' data systems and can be used to retrieve customer data. Each value of the nominated fields identifies a unique customer in the business. The value is hashed and makes up the other part of the table. The lookup table is always stored by the enterprise on their local systems.

Under direct action by the business's systems administrators, the first metamodel file is exported and uploaded to the distributed ledger. For any metamodel, the distributed ledger generates cryptographic hashes for the metamodel, establishing a unique identifier against which to track future interactions.

The (top-level) hash for each locally held customer primary key value is also stored, for a one-to-one correspondence between all consumer identification keys and this hash. The customer primary and associated keys are never exported, or uploaded to an alternate location. Only the hash is provided whenever a request is made. This guarantees only the enterprise retains the control and has visibility over all customer data. It also enables destruction of the metamodel data graph at any time by simple, local deletion of the primary key/hash index.

Each metamodel contains a map of the underlying consumer data fields collected by business's and their corresponding “privacy setting” (“public” or “private”). Tracking of any and all data interactions within the business's consumer privacy data management ecosystem is via the customer primary key hash and never through the primary identification keys from the customers' databases.

Metamodel data interactions take one of two forms. The first is to generate a consumer data privacy report, as per CCPA requirements. A request is made to the embodiment systems, providing with it a primary key hash. The incoming hash is used to search the distributed ledger or blockchain for all related transactions, which are sent in the request response. The returned set of transaction data is then utilized to generate a PDF format report that can be viewed, printed, or redistributed on to the consumer.

A second type of request is to update a specific consumer's metamodel. Again, a primary key hash is sent with the request and the current, if any, metamodel returned. The web browser facing interface enables system administrators to update the model's fields privacy settings in any data field, which is then uploaded back to the distributed ledger or blockchain as an immutable transaction. Because all interactions are written onto the distributed ledger or blockchain, a complete (auditable) history of enterprise customers ‘private data management and chain of provenance is available.

### A “Push” Model of Metamodel Generation Ensures Privacy at the Local Enterprise Platform

In preferred embodiments, a “push” model is used for all data transfers, so that information control is always held and retained by the source, vendor or business. This feature is valuable and unique to embodiments described herein in view of the prior art. A “push” model is key to retaining and ensuring, without compromise, enterprise control of their customers' data.

Embodiments start by locally mapping the metadata (e.g. as a metamodel) of a business's databases and data systems to a distributed ledger or blockchain service. Described elsewhere herein, this map is a collection of metamodels. A software application (specifically created for this purpose, also called a “creation app”) on the enterprise system scans these data sources, linking together the underlying architecture in a discovery process as to what data fields have been collected by the enterprise, and on which systems the collected data resides.

A next step is to generate a second text or binary file, with a table identifying the nominated primary keys for the business's customer accounts. All output is saved by the software application on the local enterprise platform. Under direct action by the business's systems administrators, the first metamodel file is exported and uploaded for processing by the distributed ledger or blockchain (such as BigChain DB, Hyperledger Fabric, Substrate or Polkadot).

For any metamodel, the distributed ledger or blockchain generates a cryptographic hash in the business's system, establishing a unique identifier against which to track future interactions. A (top-level) hash for each locally held customer primary key is also stored, for a one-time correspondence between all consumer identification keys and this hash.

Only the hash is provided whenever a request is made of the metamodel. This guarantees only the enterprise retains the control and has visibility over all customer data. It also enables destruction of the metamodel at any time by simple, local deletion of the primary key/hash index. No action needs to be taken by the distributed ledger or blockchain.

### Top-Level Features

Embodiments of the present invention comprise a comprehensive data privacy management toolkit based on distributed ledger or blockchain technology. Preferably, embodiments enable businesses to implement compliance solutions in their existing data systems for CCPA or other data privacy laws and regulations, with a focus on data inventory management, tracking consumer rights request processes, and auditing and reporting functions.

More particularly, embodiments of the present invention preferably comprise the following features, although not all features are necessary to practice the embodiments described herein.

1. Data Inventory Management. Many of the regulatory requirements in the CCPA and similar laws and regulations focus on tracking consumer data that is collected, stored, and processes in a business's or organization's data systems. In order to achieve CCPA compliance, businesses need to employ robust digital tools to reliably track data flows in and out of the data systems they control. Preferred embodiments offer a distributed ledger or blockchain tool for data inventory management, where data inventory is tracked through its metadata. In this way, preferred embodiments are a non-intrusive toolkit capable of cataloguing and tracking data inventory without collecting, storing, or processing any consumer data. Once deployed, data inventory as well as data logs can be tracked and archived on an immutable distributed ledger or blockchain. This assures that data records generate a robust audit trail and cannot be tampered with or altered. Data records written to the distributed ledger or blockchain may be queried by system administrators and used to generate reports on data management activities.

2. Tracking Consumer Request Processes. Preferred embodiments help businesses operationalize Consumer Request processes by tracking incoming requests and outgoing responses as data points that are tracked on the distributed ledger or blockchain. Preferred embodiments track these processes by time stamping activities related to handling consumer requests, and providing auditable data records of consumer request activities. The CCPA and other consumer privacy laws grant consumers the ability to bring many different types of consumer requests to entities that collect their personal information. These can include consumer requests to ‘Delete’ personal information, ‘Disclose’ which parties have gained access to personal information, to learn what processing has been performed on their data, and more. It is important for compliant businesses to not only implement workflow processes that satisfy the basic handling requirements for consumer requests, but also to document and archive handling of such requests. Thus, preferred embodiments render an effective tool for implementing this.

3. Data Mapping. Preferred embodiments generate a data map, also described as a metamodel, to identify what data assets have been collected about consumers and where those data assets are located within an organization's data systems. To create the metamodel, metadata is derived from the database schemas, collections and other sources where the consumer's personal information is stored. A metamodel of the organization's databases and data systems is then generated. The metamodel data graph is a data graph where the vertices of the data graph are the tables of an SQL database or the collections of a document database. An edge between two vertices exists if a field containing personal information is linked via a database key, either explicitly or implicitly, to another table or collection containing additional data related to the consumer. If the data repository for the organization was purely an SQL database with multiple tables then the metamodel would resemble the data graph topology of an Entity-Relationship diagram, but document databases and other forms of data storage are included in the metamodel. The metamodel is used to map data assets collected and stored by an organization, to track changes to consumer data over time, and to generate reporting for consumer request processes and regulatory reporting requirements. Embodiments allow organizations to map their data systems in a way that enables automated handling of consumer requests and regulatory auditing and reporting.

4. Auditing and Reporting. Preferred embodiments enable real time auditing of data tracking and data logs, which can be used to generate reports. Since the CCPA includes requirements for data reporting and disclosures to users, this tool will be highly useful to businesses that seek to issue regular reports on how consumer data is being used and whether third party processors have access to the data. Preferred embodiments enable businesses to generate a number of standard forms, and can be customized to accommodate any desired form of reporting, including across jurisdictions with different reporting requirments. It is likely that, as a result of CCPA going into effect, businesses will issue notices and disclosures to consumers regarding data privacy policies and changes more regularly. With this in mind, embodiments offer an easy way to verify and track notices, disclosures, Opt-Out links, and updates to data privacy policies. Each of these events can be written to the blockchain, time stamped, and thereby adds to the audit trail. Embodiments will save businesses time and resources by automating these processes and providing a robust audit trail.

5. Dashboard and Control Monitoring. Embodiments provide dashboard features to help users manage the data toolkit and to handle their data privacy concerns. Dashboards may be customized to accommodate a variety of needs and to improve user experience. Businesses that create user profiles often integrate personal information from many different sources. Dashboards also allow users to change and track consumer privacy preferences from the Dashboard itself, rather than requiring users to perform manual data entry in various databases.

6. Consent Management. Embodiments provide tools that allow users to automate and easily manage consumer consent requests, including Opt-In and Opt-Out requests. These consent management tools are connected with the blockchain and the metamodel, and therefore generate real-time tracking of consent management.

7. Targeted Response To Data Breach. Preferred embodiments allow users to leverage the metamodel technology in the aftermath of a data breach to ascertain which parts of the user's data system were impacted, and which consumers' data was breached. Embodiments therefore provide users with tools to assess the impact of data breach and to make more targeted response to breaches of consumer data.

8. Data Subject Access Request (DSAR). Preferred Embodiments help users automate and operationalize DSARs from consumer. A Data Subject Access Request (DSAR) is a submission by an individual (data subject) to a business asking to know what personal information of theirs has been collected and stored as well as how it is being used. Data subjects can also use a DSAR to ask that certain actions be taken with their data. DSARs are one component of consumer request processes and are rights generally granted to consumers under CCPA and other consumer privacy laws, regulations, rules, and policies. Embodiments help users automate DSARs by tracking what data has been collected about consumers, by automating any consumer requests, and by generating audit trails and automated reporting.

### Tracking Ccpa Consumer Data Requests

The CCPA has provisions for consumers to make requests regarding their personal information that a business must satisfy within a specified window of time. Data inventory on the distributed ledger or blockchain can be used to:
(a) Expedite CCPA consumer data requests by using the metadata stored on the distributed ledger or blockchain to find every occurrence in the collective data pool held by companies; and
(b) Create an immutable audit trail of the request so that businesses can verify to themselves and to consumers that any request has been satisfactorily fulfilled.

Consumer Request tracking with preferred embodiments of the present invention proceed according to the following process:
1. A consumer makes a request to be validated by the business. Consumer credentials are matched against the business' method for customer identification and the associated unique identifiers under which the consumer data is stored are obtained. The Consumer Request is “stamped” onto the distributed ledger or blockchain.
2. The request is executed against the current state of the metadata on the distributed ledger or blockchain and a manifest of all fields, tables and organization tools (such as CRM tools) where stored customer data is returned. This list is written onto the distributed ledger or blockchain and connected directly to the request as part of a comprehensive audit trail.
3. The produced manifest is utilized to service the request by running through it, applying each action required by the request to each database, database table or collection, and management tool. The actions taken on each of the databases, database tables, collections and third-party tools are documented and stored on the distributed ledger or blockchain against the original request.
4. The request outcomes are sent to the consumer and all outputs are written to the distributed ledger or blockchain. Reports may be generated showing this process to business administrators and consumers.

### Using Metadata to Protect Personal Information

Preferred embodiments do not store any sensitive data or any consumer information on the distributed ledger or blockchain. Recall that data stored on the distributed ledger or blockchain is metadata specifying what data has been stored about a consumer, and where it is located. Thus, a user request is formulated as a request on the distributed ledger or blockchain and the metamodel is returned. The metamodel returned is the subset of the attributes in the metamodel relevant to consumer request. The metamodel is used to query the databases and tables required to satisfy the request and reported to back to the consumer along with the distributed ledger or blockchain certificates. Personal information of a particular user, consumer or individual is not available on the distributed ledger or blockchain—the metamodel returns only metadata—attributes and where to find such personal information.

The distributed ledger or blockchain is also used to store an audit trail for a consumer against their original request and this audit trail uses a blockchain-generated digital identity. The digital identity is an alphanumeric hash used to construct a history of data activities about an individual account in the user's data systems. It does not contain any identifying information about the consumer, it is merely a digital identifier. The initial request is stored on the distributed ledger or blockchain, and linked back to the consumer's stored metamodel via the consumer's digital identity. Each stage of the request handling is logged as a transaction on the distributed ledger or blockchain finalized on the distributed ledger or blockchain. Therefore, it is not possible to retrieve the original personal information or data from the distributed ledger or blockchain—the distributed ledger or blockchain (e.g. metamodel data graph) is at best a resource to point where the personal information exists (e.g. the enterprise data systems). This is further contrasted in the differences between FIG. 4 (in the prior art where personal information is transmitted through a firewall) and FIG. 5 (where only metadata is pushed through the firewall).

### Auditing and Reporting

Preferred embodiments use a micro-services architecture, integrated into the distributed ledger or blockchain system in order to perform auditing and reporting functions. Various micro-services are used to perform the functions necessary to complete report generation and data population activities as may be needed by users.
a) Verification, Auditing, Report Generation Request Handlers. Each of the core services within the control layer receive a validated request specifically routed to them, handle the request, and then pass the results back. Most requests will only go as far as the model layer.
b) Searching, report generation and querying. Micro-services connect to the databases services in the model layer.
c) Auditing. Audits on preferred embodiments may be designated for a single user account or for specified data sets.
d) Verification. Verification of the database against the distributed ledger or blockchain seeks to affirm that the data in the database is consistent with the distributed ledger or blockchain.

Micro services in preferred embodiments enable a high degree of flexibility. One place this can be applied is customizing the way that reporting features work. Businesses may have specific requests for how to format, design, and populate reports related to their data privacy and CCPA compliance activities. In preferred embodiments, this is handled easily and quickly.

### Data Certification

In preferred embodiments, a ledger of record (on a distributed ledger or blockchain) will generate reports that show data activities tracked on the system, along with distributed ledger or blockchain verification information. To enhance user experience, distributed ledger or blockchain verified data processes will be displayed with an icon. This could include issuance of a consumer notice (verified and stamped on distributed ledger or blockchain), processing of a consumer request, etc.

When a user places his/her curser on the icon, they preferably will be able to see information related to the distributed ledger or blockchain transaction hash. When computer curser is placed on top, users will be able to see the distributed ledger or blockchain transaction hash, time stamp, and other information validated on the distributed ledger or blockchain.

Reports preferably show the record of activity for a particular user account or data set. All tracked activities related to the searched account preferably will be displayed in the report generator, along with distributed ledger or blockchain certification icons where relevant.

### Data Inventory & Privacy Management

Many of the regulatory requirements in the CCPA, and in privacy regulations in general, focus on tracking consumer data as it enters and is stored on a company's data system. The focus is also on the uses of private data and where the data is used or sent. Data inventory management tracks customer data through the data lifecycle.

The CCPA and general privacy requirements also require that consumer requests be tracked. For business the consequence is that with the diversity of data sources and repositories keeping track of which customers have opted in, which customers have made requests, and which requests have been complied with is an overhead.

Embodiments of the present invention achieve privacy management through one or more of the following three mechanisms.

1. No consumer data is stored. All the analysis and management is done using metadata that is obtained directly from the data stores.

2. A metamodel of the data system is created using just the metadata of the data system and the metamodel (rather than personal information) is used for tracking and managing consumer requests.

3. The status of each customer's data privacy is tracked against the metamodel.

### System Implementation

A system or embodiment of the presently disclosed invention generally comprises certain resources, namely: definitions of the metamodel, the processes for constructing the metamodel from the client data, the operations that are performed on the metamodel, the association of business customers to their own private metamodel, the operations on the customer privacy settings, operations on notifications and a map of how all of those resources and operations are mapped onto a distributed ledger or blockchain. In preferred embodiments all of these operations are mapped to a distributed ledger or blockchain.

### Overview of Components of the System

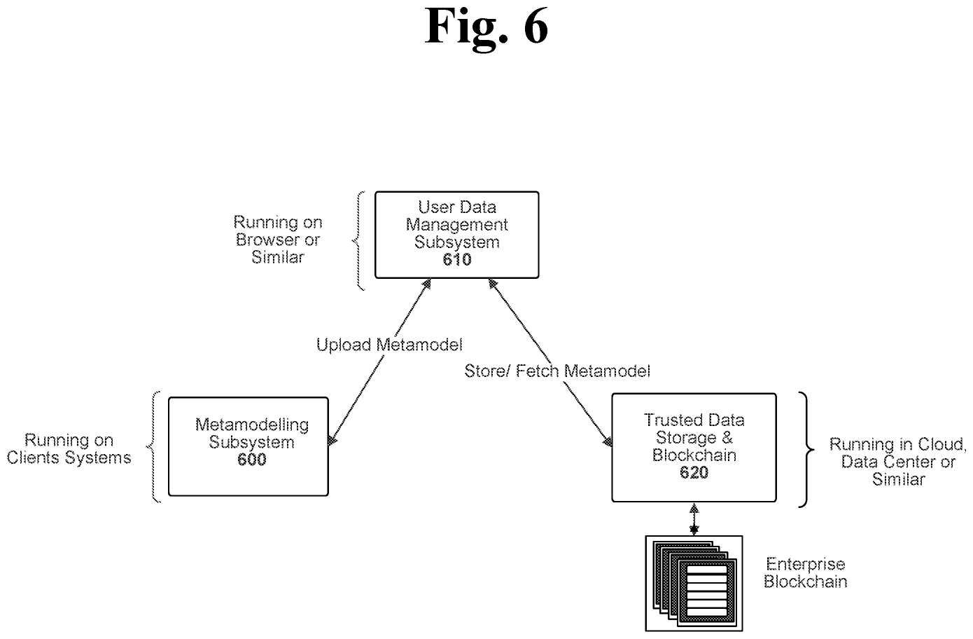

Turning to FIG. 6, the major functional components are illustrated for creating an initial metamodel stored in a distributed ledger (e.g. blockchain), together with where the functional components are executed.

A Metamodeling Subsystem 600 runs or executes on a client's system (e.g. via the client's CPU). This may be an executable program or an application that executes on top of an API (e.g. a program in an interpreted language, a plug-in to a browser, an app, etc.). The metamodeling subsystem 600 is preferably intended to run on the client's system so that it can readily access and harvest data from the client data systems, connect to client databases and spreadsheet repositories, and (preferably simultaneously) execute a data table fusion process.

A User Data Management Subsystem 610 preferably runs in a browser or alternatively can be run on the client's data system. The purpose of this subsystem is to receive the metamodel generated from the data table fusion process (executed by metamodeling subsystem 600) and upload it to a trusted data storage subsystem 620.

The Trusted Data Storage Subsystem & Blockchain 620 may run on local or remote servers, or in a cloud, converting the metamodel into blockchain transactions. The Trusted Data Storage Subsystem & Blockchain manages the blockchain interaction between the data management subsystem and the metamodel stored on the blockchain.

### Creation Process

A distributed ledger must be deployed before a metamodel can be created and stored. There are two possibilities:

1A. A blockchain is deployed for the client organization taking into account their special requirements; or

1B. The client organization can join an existing blockchain as part of a multi-tenant deployment.

2. Connect a software application to the client database management systems (DBMS). A client may use one or more database management systems (e.g. they may use SQL databases like Oracle, Postgres or MySQL in conjunction with document databases like MongoDB, Amazon DynamoDB or Google Firestore). Client credentials will typically be required to connect to a DBMS. This step involves the client connecting to their database management systems through the metamodeling subsystem.

3. Connect each database within DBMS to the software application. A DMS may contain several databases. This step involves the client connecting to individual databases within a DBMS by supply the necessary credentials using the metamodeling subsystem.

4. For each DBMS, for each database, using the software application extract each table from the database and all of fields. Determine which fields are primary keys for the collection.

5. Apply the Table Fusion Process' (PTF Process) to the complete set of all tables and fields extracted in the step above. The result is a metamodel data graph that links tables within databases and database management systems, and between databases, and database management systems. The PTF Process also links tables in databases and database management systems on one site or organizations with those on another site or organization provided both sites are running the metamodeling subsystem. The resulting data graph is called the ‘Table Fusion data graph’ for the client data.

6. For each vertex and edge in the Table Fusion data graph add the default privacy information.

7. The client sends the augmented Table Fusion data graph to the Data Management Subsystem.

8. Once the client is satisfied with the Table Fusion data graph the client sends it to the Trusted Storage Blockchain Subsystem.

9. Calculate the connected components of the Table Fusion data graph. A connected-component of the metamodel data graph is a subset of the vertices of the metamodel data graph where every pair of vertices is connected by a path of edges. In terms of privacy, the data in any table in a connected component can be joined to the data in any other table in the connected component to reveal private information about a customer. This idea of fusing data records from different data sources is exactly how data aggregators operate

10. Transform the initial metamodel into the transaction structure of the blockchain and store the initial Metamodel on Blockchain.

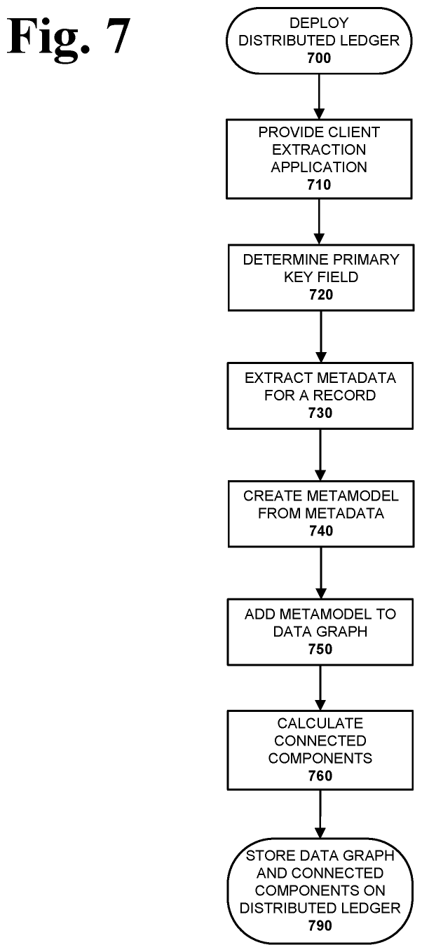

Turning to FIG. 7, a flowchart summarizing these steps is illustrated.

In step 700, a distributed ledger or blockchain is deployed, as described above in steps 1A or 1B.

In step 710, a client extraction utility or subsystem (also known as a “creation app”) is provided, allowing extraction/creation of metadata from the databases. The creation app is preferably installed on the client data systems.

In step 720, a primary key field is identified, providing an index for the distributed ledger or blockchain for future storage/lookup of individual metamodels.

In step 730, the database is analyzed, thereby extracting/creating metadata for a given record.

In step 740, the metadata is used to create a metamodel.

In step 750, the metamodel is added to a metamodel data graph, providing a container/vehicle for analysis and manipulation of the metamodels. If no metamodel data graph is available for the first metamodel to be added, a metamodel data graph is created.

It is noted that steps 730 through 750 may be repeated for any number of records/persons in the database(s).

In step 760, an operation of calculating the connected components is executed prior to storage of the metamodels on the distributed ledger.

In step 790, the process completes with the metamodel(s) and connected components being stored on the distributed ledger or blockchain.

### Request Tracking

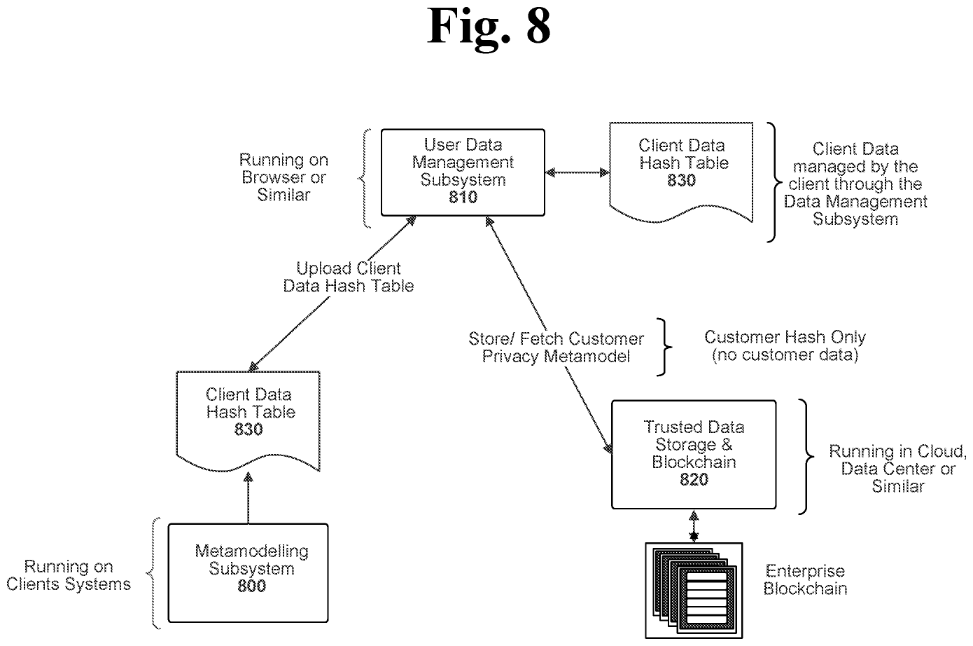

Turning to FIG. 8, the major functional components of a request tracking subsystem are the similar to the metamodeling subsystem in FIG. 6, with some additions and nuances.

A Metamodeling Subsystem 800 runs or executes on a client's system (e.g. via the client's CPU). This may be an executable program or an application that executes on top of an API (e.g. a program in an interpreted language, a plug-in to a browser, an app, etc.). The metamodeling subsystem 800 is preferably intended to run on the client's system so that it can readily access and harvest data from the client data systems, connect to client databases and spreadsheet repositories, and (preferably simultaneously) execute a data table fusion process. A client data hash table 830 is created by the metamodeling subsystem 800 and stored on the client's system.

A User Data Management Subsystem 810 preferably runs in a browser or alternatively can be run on the client's data system. The purpose of this subsystem is to receive the metamodel generated from the data table fusion process (executed by metamodeling subsystem 800) and upload it to a trusted data storage subsystem 820. The user data management subsystem 810 preferably also receives the client data hash table 830, which also translates between human readable customer data and hashed (e.g. encrypted) data as needed for administrative purposes.

The Trusted Data Storage Subsystem & Blockchain 820 may run on local or remote servers, or in a cloud, converting the metamodel into blockchain transactions. The Trusted Data Storage Subsystem & Blockchain manages the blockchain interaction between the data management subsystem and the metamodel stored on the blockchain.

There are two sub-processes involved in consumer request tracking and administration: (1) the creation of the Client Data Hash table which is done on the client's data systems using the metamodeling subsystem; and (2) tracking and updating customer requests which is done using the data management subsystem and the trusted data subsystem containing the blockchain.

The steps involved continue from the 10 step process described in the previous section:

11. The client nominates the DBMS, database, data table and fields to use for linking between distributed ledger and their customer data tables. They do this using the metamodeling subsystem.

12. The metamodeling subsystem connects to the nominated table, reads each row of that table, projects onto the fields and hashes each resulting row. The metamodeling subsystem stores the row data together with the row hash in a file called the Client Data Hash Table on the client's systems. The Client Data Hash Table is never uploaded to the embodiment servers, or the cloud.

13. The Client Hash Table is loaded into the front-end Data Management tool running in the browser and stored securely on the browser. To use the client data hash table for tracking and administering customer requests it is loaded and securely stored in each session into the data management system running in the browser or similar from end. The hashes, and only the hashes, are used for administration and client request tracking.

### Administering a Consumer Request

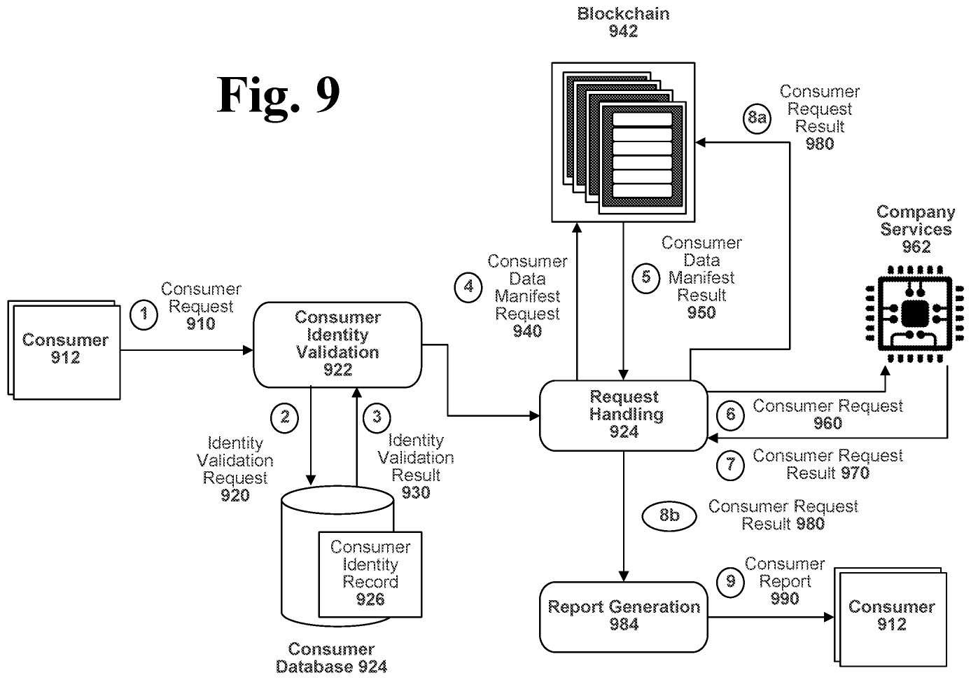

Turning to FIG. 9, the top level steps and resources involved in administering a consumer request are illustrated together.

A consumer 912 makes a consumer request 910, such as a request to opt-out, request to provide a report, etc.

To fulfill the consumer request 910, it is preferable to validate consumer identity 922 by first converting the consumer request 910 into a consumer business digital identity or identity validation request 920 (e.g. from the client data hash table). In this regard, a consumer identity record 926 is either retrieved (if present in a consumer database 924), or alternatively a new consumer identity record 926 is added to the consumer database 924.

Once the validation (or new creation) has been completed, an identity validation result 930 completes the consumer identity validation 922, and processing is transferred to request handling 924.

Preferably, a consumer data manifest request 940 is transferred and stored to the distributed ledger or blockchain 942, evidencing the consumer request 940 has been received and is being processed.

Data relevant to the consumer data manifest request 940 is also retrieved from the blockchain 942 and passed back to the request handler 924 via a consumer data manifest result 950.

Depending upon the nature of the consumer request 910, it may require company services 962 to execute tasks (e.g. remove a consumer from an opt-in or opt-out status, etc.). These tasks are completed by the company services 962, and the consumer request result 970 is provided back to request handling 924.

At this juncture, with the consumer request 910 having been stored on the blockchain 942 and processed by company services 962, a consumer request result 980 is both stored or upserted into the blockchain 942, as well as provided for report generation 984.

In a final step, a consumer report 990 from report generation 984 is provided back to the consumer 912.

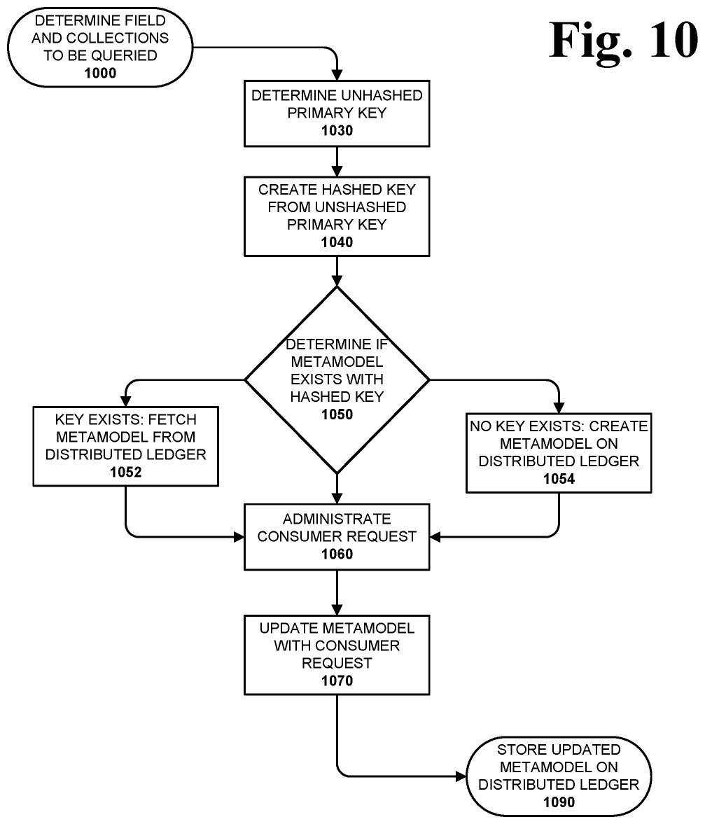

Turning to FIG. 10, a flowchart summarizing these steps is illustrated.

In step 1000, the fields and collections (e.g. databases) to be queried are determined.

In step 1030, an unhashed primary key is determined, which will be used in the next step.

In step 1040, the unhashed primary key is utilized to create a hashed key.

In step 1050, the hashed key from step 1040 is checked as to whether it exists on the distributed ledger or blockchain. If the hashed key exists, in step 1052 the metamodel for that hashed key is retrieved from the distributed ledger or blockchain. If hashed key exists, in step 1054 a new metamodel for that hashed key is created and stored on the distributed ledger or blockchain.

In step 1060, the consumer request is administrated, such as changing privacy settings for various data fields, requesting a report, or other action.

In step 1070, the metamodel is updated with the consumer request administrated in step 1060.

In step 1090, the updated metamodel from step 1070 is stored on, or upserted into, the distributed ledger or blockchain.

### Javascript

There are a number of advantages to employing Javascript for both the user interface and server API: speed, versatility, rapid development, simplicity, “native” JSON, popularity, shared code, interoperability, dynamic ORM, and extended functionality via third party modules. But, more importantly, use of Javascript makes it straightforward to audit, verify and validate the codebase.

Javascript is used for both the user interface and server implementation. It is utilized for input of user input from browser from the data management subsystem, input from the client databases in the metamodeling subsystem. It is also used for output from the data management subsystem are updates to the metamodel; output from the metamodeling subsystem are the table fusion data graph sent to the trusted data storage and the client data hash table stored on the client's systems.

### Parse Server

The Parse Server and associated SDKs provide a robust, well maintained and documented API to bridge the UI and Privacy Lock backend systems. As with using Javascript it facilitates verification and validation of the Privacy Lock codebase. Equally important it enables a “separation of concerns” architecture underpinned by server micro services, allowing for the distributed ledger or blockchain to operate independently of any web services. The Parse Server can be updated, extended and enhanced without impacting the distributed ledger or blockchain and presents a low-cost, open source, robust option.

### Graph Visualization/Database Libraries

As a commercial product, preferred embodiments are strongly influenced not only by range of unique capabilities, but also by its ease of use provided through the “user experience” (UX). Enterprise data management systems can contain hundreds of data tables and thousands of accompanying data fields. Having a data graph visualization component as part of any product offering enhances the UX.

### Bigchain db, Hyperledger Fabric, Substrate & Polkadot

BigchainDB is a blockchain framework optimized for use in data applications that uses the Tendermint consensus to perform validation.

Hyperledger Fabric, Substrate and Polkadot are alternate frameworks for trusted data storage. Hyperledger Fabric, Substrate and Polkadot are alternative blockchain frameworks to BigChain. Each framework has distinct elements from the others and are maintained by different developer communities. Embodiments may be deployed using one or more blockchain frameworks. It is customized to accommodate the specific workflows and data functions of embodiments herein.

### Mongo DB, Arango DB & Interplanetary File System

Mongo DB and Arango are both types of databases used in the architecture of embodiments described herein. Arango is a data graph database and stores data that is structured for the kinds of relational data graphs used in preferred embodiments to manage and track data privacy interactions.

Interplanetary File System (IPFS) is used as part of the data store solution for preferred embodiments, and it provides content addressing.

### Progressive Web Applications

Until recently, applications for interacting with web (Cloud) based resources fell into one of three possible camps: desktop based, websites, or mobile applications. With Progressive Web Applications (PWAs) it is now possible to build with a single codebase viable applications that can target all three platforms. They are designed to combine the best features of mobile applications, with speed and offline usage, but without the overhead of deployment to an App store. PWAs are reliable, fast and engaging, with a UI/UX that feels natural deployed on a browser, mobile device or desktop. In preferred embodiments, PWAs are preferably utilized for both front-end and back-end user interfaces.

### NOSQL Databases

Compared with schema driven data stores, like MySQL or Postgres, NoSQL (not-only SQL) database can be much better suited for storing structured, semi-structured, or unstructured data. Their intrinsic flexibility, ease of development and fit as scalable, performant document stores position them as a first choice for modern web applications. It is preferable to utilize NoSQL databases in preferred embodiments, although other databases can be used with success.

### Content Addressable Links

Content addressable links—form an important anchor as part of the decentralized (P2P) web movement. While http:// and https:// protocol links identify and point to content by its location, content addressable links do not. And with http(s)://whoever controls that location also controls the content. Content addressable links identify content through its cryptographic hash, providing both verification of the content and a unique location index for it. They create a persistent data structure for content and a future (decentralized) web independent of the current domain naming (DNS) and certificate authority systems. In preferred embodiments, it is recommended to utilize content addressable links with respect to the metamodel data graph and data stored on the distributed ledger or blockchain.

### Relational Databases

Relational database management systems are used to define any number of relational databases.

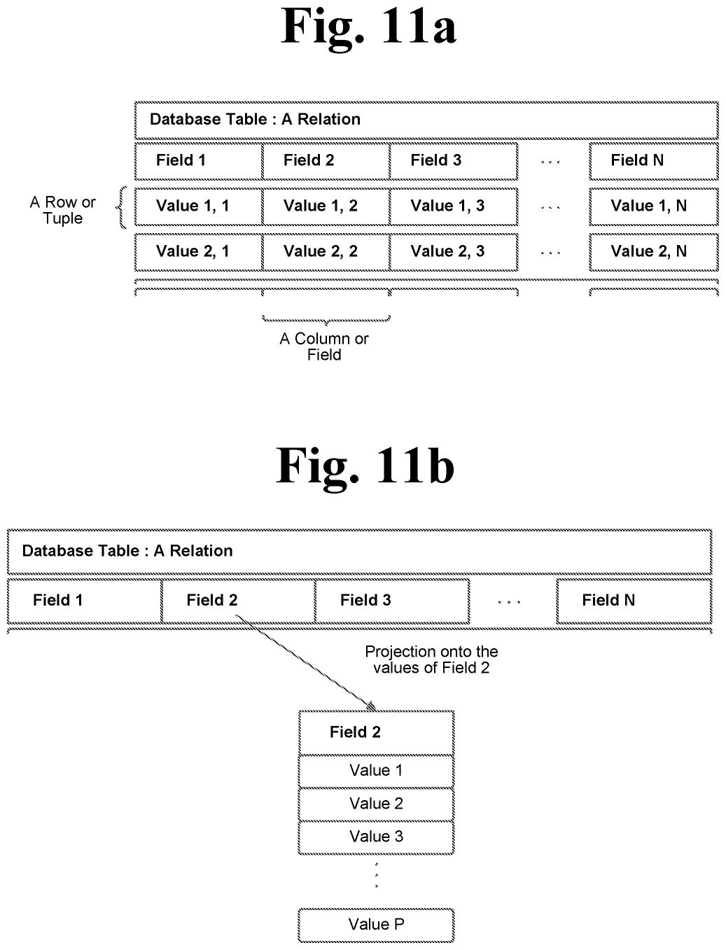

Turning to FIG. 11a, a relational database is illustrated. Each relational database consists of a set of tables. In turn, each table has a well-defined structure consisting of a sequence of fields, or columns, each with a field identifier, a field type and other metadata relevant to the specific database management system. The data is stored in tables and must be consistent with the field descriptions.

A database table is a mathematical relation which we write as R(A₁, . . . , A_{N}). Here, R is the table name, and the {Aᵢ} are the FIELD names. The values {value(i, j)} for row i and FIELD j are where any private data is stored, while the FIELDs, FIELD names, their types and any FIELD data constitute the meta data for the table. In relational databases, the FIELDs and their types and metadata is called the ‘Logical Schema’.

A Field, or a set of Fields, is said to be a Primary Key for a table if the value of the primary key uniquely identifies each row. From a data privacy perspective, the primary keys can be used to find private data.

Relational database management systems use the Structured Query Language or SQL to search and retrieve rows, add new rows or delete rows form a table.

### Search and Retrieval Operators

The SELECT statement can retrieve any cell, or ‘block’ of cells in a table. The form of an SQL statements is

SELECT A₁,A₂, . . . ,Aₚ FROM<Table>WHERE <Condition>;

Where the Aᵢ specify the FIELDs, <Table> specifies the Table to be queried and <Condition> is a boolean expression that is used to filet the rows. A select statement will select all the rows from the nominated Table where the Condition is true and then returns just the values in the nominated FIELDs A₁, . . . , Aₚ. In SQL parlance, the filtering of the rows is referred to as Selection and the restrictions the values in the nominated FIELDs as Projection.

### Insertion, Update and Retrieval

INSERT INTO<Table>(A₁, . . . ,Aₚ)VALUES(v₁, . . . ,vₚ)

The operation is used to insert the values v₁, . . . , vₚ into the nominated table into FIELDs A₁, . . . , Aₚ. Along similar lines there is

UPDATE<Table>SET Aⱼ=vⱼ WHERE Aₖ=vₖ;

The update operation updates the values in the nominated table in FIELD Aⱼ to vⱼ for each row where the FIELD Aₖ has the value vₖ. Finally, in the current set is the delete operation

DELETE FROM <TABLE>WHERE Aⱼ=vⱼ;

The delete operation deletes all the rows in the nominated table where the FIELD Aⱼ has the value vⱼ.

### Joining Tables

An important operation in SQL from a privacy perspective is the Join operation. There are a number of different forms of join, but they all achieve the same goal of joining two or more tables together. The general

JOIN Table₁,Table₂ ON A₁, . . . Aₚ;

The Join operation joins together Table₁ and Table₂ where Table₁ and Table₂ share the common FIELDs A₁ . . . , A_{P} and the values for those FIELDs are equal between the two tables. A Join operation combines the FIELDs of the two nominated tables on the common FIELD names.

### Sharding and Replication

Sharing and Replication are operations on tables. Sharding is used when a table grows too large to access efficiently. A sharded table is partitioned and distributed potentially, over a number of servers. A simpler form of sharding is partitioning where a table is again partitioned but is not distributed over different servers.

Replication occurs when a copy of the table is maintained on multiple servers. The reason for replication is often for fault tolerance of the data.

### Unstructured Data and Document Databases

A form of NoSQL database where the data is stored in ‘documents’. Each document is a JSON object (e.g. Document database Amazon DocumentDB, ArangoDB, MongoDB, CosmosDB, CouchDB and Couch Server).

### Data Maps Based on Data Graph Theory

There are at least two data graph theoretic models that can be associated with privacy sets. We call them: (1) the ‘privacy field’ data graph; and (2) the ‘privacy relations’ model. The first step is to create what we call the Join Compatibility data graph.

1. The Join Compatibility data graph (the JC data graph) is defined as follows.

Vertices: First define the of vertices V_{DB} for the database DB which is given by:

V_{DB}={R|∃DB·R∈Relations(DB)}

The databases over which the vertex set is defined are the databases nominated for inclusion in privacy monitoring from any database management system or repository in an organization's data ecosystem. Let the set of all databases from all database management systems in the organization's data ecosystem nominated for privacy be D. The set of vertices for the JC data graph is V_{JC}=UV_{DB}.

Edges: The goal is to define two relations R_{A} and R_{B} to be Join Compatible if one relation contains FIELDs that are also contained in the other relation. However, fields do not always have the same name across databases or relations despite labelling the same data, so the simple definition that FIELDS(R_{A}) n FIELDS(R_{B})≠Øimplies join compatibility works in the case of relations where one relation has the foreign keys for another. It will not work in more general across cases where different relations in different tables share values but not necessarily key fields.

Turning to FIG. 11b, to handle the more general case, we extend the idea of a foreign key as follows. The projection of a relation R onto a field Fⱼ is defined as follows Π_{RF}_{ⱼ}: F₁×F₂× . . . F_{N}→Fⱼ where Π_{RF}_{ⱼ}( [symbol] v₁, . . . , vⱼ, . . . , v_{N} [symbol] )=vⱼ for every row [symbol] v₁, . . . , v_{N} [symbol] ∈R. The set of values projected from R, that is to say the range Π_{RF}_{ⱼ}, is denoted P_{RF}_{ⱼ}.

We now define two relations R_{A} and R_{B}, possibly from different databases and possibly from different database management systems, to be Join Compatible if it meets the following condition: there are columns of values in R_{A} and R_{B} that have non empty intersections of values that can be used to join relations R_{A} and R_{B}.

Formally, two relations R_{A} and R_{B} are Join Compatible if there exists a projection Π_{R}_{_{A}}_{,F}_{ⱼ} from R_{A} and a projection Π_{R}_{_{B}}_{F}_{ₖ} from R_{B} such that P_{R}_{_{A}}_{F}_{ⱼ} ∩P_{R}_{_{B}}_{F}_{ₖ}≠Ø. An edge in the JC data graph exists between two relations if they are join compatible in this sense.

The set of all edges in the JC data graph is the set

E_{JC}={(R_{A},R_{B})|R_{A},R_{B}∈V_{JC} and ∃Fⱼ,Fₖ·P_{R}_{_{A}}_{F}_{ⱼ}∩P_{R}_{_{B}}_{F}_{ₖ}≠Ø}

The JC data graph is the defined by the pair G_{JC}=(V_{JC},E_{JC}).

2. The Privacy Fields Model (the PF Model): The privacy fields model is a subgraph of the join compatibility data graph constructed as follows. The set of vertices is generated X_{PA}={p|p ∈PrivacyFields} where the set Privacy Fields is the set of fields that identify an individual or private citizen directly. As an example, a set of generators might be defined as follows:

X_{PA}={(name,address),socialsecurityno,creditcard,bankaccount}

X_{PA} is referred to as the Generator set for the vertices of the data graph.

Notice that as well as individual fields such as ‘social security no.’ and ‘bank account’ it is also possible to have a composite privacy field that, when taken together, also uniquely identify an individual, for example, ‘(name, address)’. The composite is also referred to as a ‘privacy field’.

The set of vertices: The privacy set, is constructed by adding fields that are ‘related’ to an element of X_{PA}. An FIELD Fⱼ is related to an element of X_{PA} if and only if (iff) Fⱼ adds further information about the individual identified by one or more of the fields in X_{PA}.

As an example, a (name, address) pair, can be used to identify a specific person. In a human resources database, the (name, address) pair can be related to a ‘Job Title’ or even a ranking in a company performance rating process.

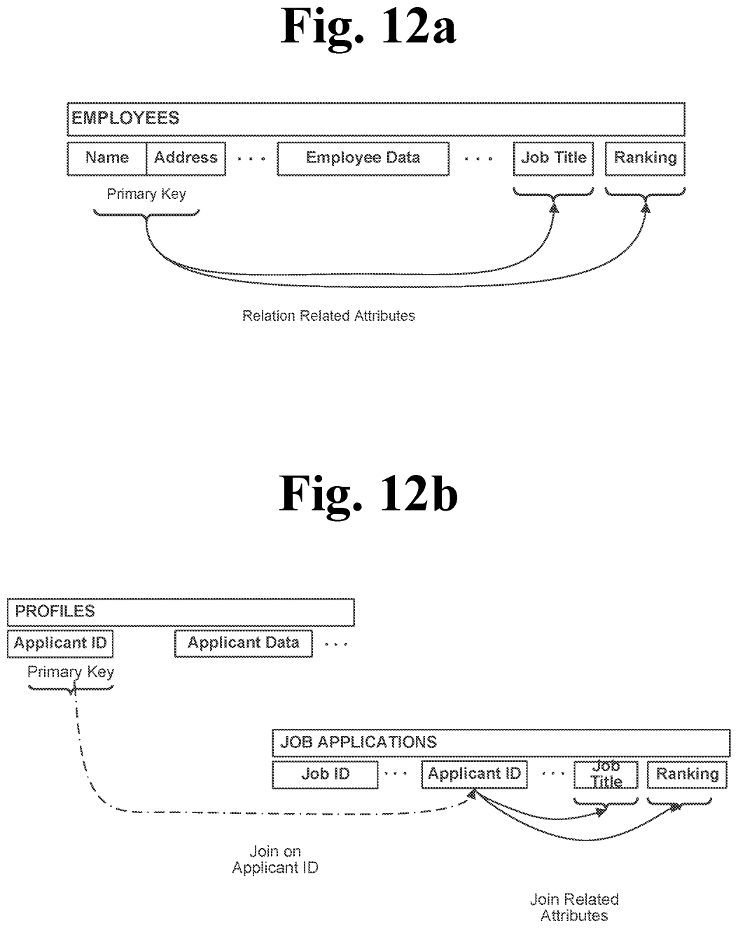

Turning to FIG. 12a, note that there are number of different possibilities here. First there is the case of related fields within a single relation. In this case the privacy field is the pair (Name, Address) and the related fields are ‘Job Title’ and ‘Ranking’. We say that ‘Job Title’ and ‘Ranking’ are revealed by (Name, Address). Think of the case where a related FIELDs ‘reveals’ more information about an individual.

Notice that a Job Title or a Ranking carries no privacy information on its own! It is only when these FIELDs are revealed by a privacy FIELD that they take on privacy significance by adding detail and extra information about the individuals identified b the privacy field.

It is also reasonable to assume that every field in a relation is revealed by in any relation that contains privacy fields!

The second case deals with the case of database joins on relational databases or their equivalents on document databases. In the case of join operations, fields may be revealed through the join operation. Turning to FIG. 12b, the situation appears as in the following diagram where a join can be performed on the ‘Applicant ID’ field.

The transitive case is also possible, where fields are revealed through multiple joins.

The set of edges: is defined by the data fields that are related to the fields in X_{PA} by means of joins. Every field Fⱼ that is related to an element of X_{PA} is reachable from X_{PA}. If the relation R_{A} containing X_{PA} can form a join with another relation R_{B} and R_{B} contains fields that can be related to X_{PA} then there is an edge from those fields to the fields in X_{PA} to which they are linked. That is to say that the set of linked fields to X_{PA} is the ‘transitive closure’ under joins and the privacy fields data graph is a connected component around X_{PA}.

Notice that the privacy fields data graph with its reliance on related fields is not easily automated. For instance, any approach would need to inherently understand that a Job Title was related to a (Name, Address) pair that identifies an individual. For practical purpose we will need a definition that is can be automated.

3. The Privacy Relations Model (the PR Model): The privacy relations model is based on ideas similar to the privacy fields model but is instead of relating fields, it relates entire relations by focusing on data graph components.

A component of an undirected data graph is an induced subgraph in which any two vertices are connected to each other by a path and no vertex in that the component is to connected to any other vertex in the data graph outside of the component.

A privacy component is an induced subgraph of the join compatibility data graph in which:
(i) At least one of the vertices in the component is a relation that contains privacy fields, that is to say, for at least one V=R(F₁, . . . , F_{N}) we have {F₁, . . . , F_{N}}∩X_{PA}≠Ø. We call any vertex with fields in X_{PA} a privacy carrying relation, and any other vertex a privacy revealing relation.
(ii) Any two vertices in the component are connected by join compatible paths.

Observe that if one of the relations in the component is a privacy carrying relation then the fields of any relation connected to the privacy carrying relation are revealed.

Approach 1
Native Mathematical Process for the Privacy Relations model

| | |
|---|---|
| 1. | Let Vertices = V_{JC}, Edges = Ø |
| 2. | Let Privacy = {r\|∃db • r ∈ V_{JC}andrisprivacycarrying} |
| 3. | Let Components = Ø, Component = Ø, Visited = Ø |
| 4. | Procedure Depth_First_Search( R_{A} ) |
| 4.1. | Visited ← Visited ∪ {R_{A}} |
| 4.2. | Connected ← {R_{B}\|(R_{A}, R_{B}) ∈ E_{JC}} |
| 4.3. | For each R_{B} ∈ Connected do |
| 4.4. | Privacy ← Privacy ∪ {R_{B}} |
| 4.5. | If R_{B} ∉ Visited then |
| 4.6. | Depth_First_Search( R_{B} ) |
| 4.7. | End |
| 4.8. | End |
| 4.9. | End |
| 5. | For each R_{A} ∈ Privacy do |
| 6. | Depth_First_Search( R_{A} ) |
| 7. | End |

Approach 1 shows the classic data graph components process adapted to computing the components of the Join Compatibility data graph.

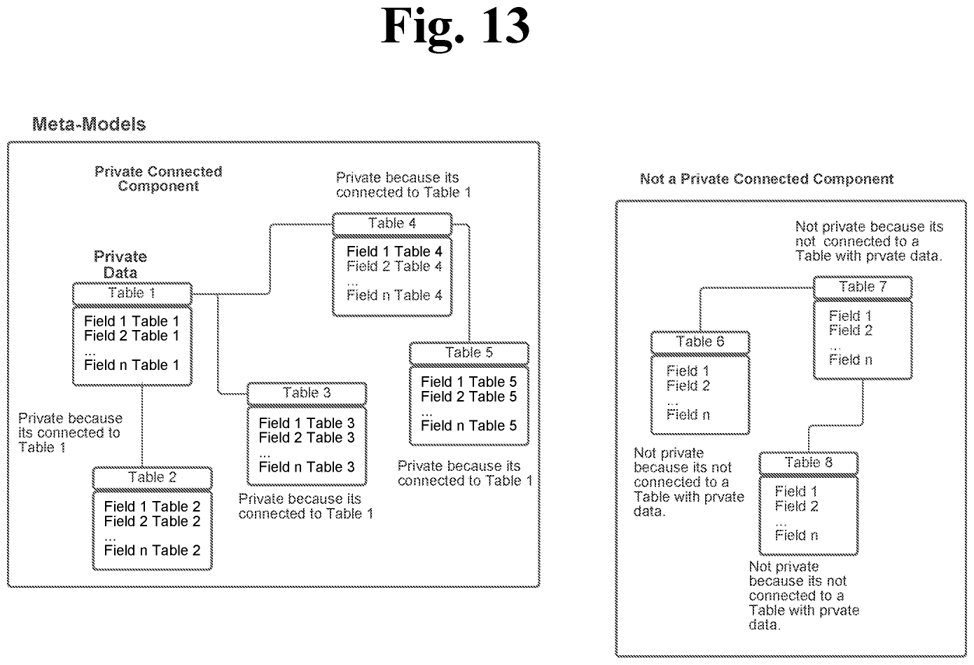

Turning to FIG. 13, an embodiment of the present invention is illustrated. Each relation in a component returned from Approach 1 consists of the table name and a list of the field names for that table. No personal information from any of the tables is involved in creating the component models.

Privacy relation models can be constructed from individual relations in relational databases, and from collections in document databases. Further, the privacy relations model can include a combination of document collections, key-value collections and relations and so it's possible to derive a single privacy data graph for the entire data ecosystem of an organization.

### Generating a Metamodel of the Organizations Data Ecosystem

The first step in Data Privacy Management is to compute the privacy relations model using Approach I. Suppose that we have a number of tables that Approach 1 separates into two components. The next stage is to map the privacy components. Approach 2 does this.

Approach 2
Marking Tables in a Component as Private

| | |
|---|---|
| 1. | For each C ∈ Component do |
| 2. | If C a contains privacy relation do |
| 3. | Mark every relation in the component as ‘Private’ |
| 4. | End |
| 5. | End |

The privacy marked set of components of the join compatibility data graph is called the Privacy Metamodel for an organization. It is denoted by Mₚ and forms the basis of most of the operations that follow. Recall that no data from the tables is a part of the metamodel.

### Privacy Operators

The framework needs to have a theory accounting for consumer request tracking and for tracking data to and from vendors. Tracking starts on the client's site from the client nominated databases.

We assume that a privacy metamodel Mₚ has been generated.

Consider an individual with private data from one of the tables, let's call them, ‘person-X’. The construction of an individual's tracking data is done in multiple steps. The individual's tracking data together with the data graph metamodel constitutes the ‘privacy trusted data store’.

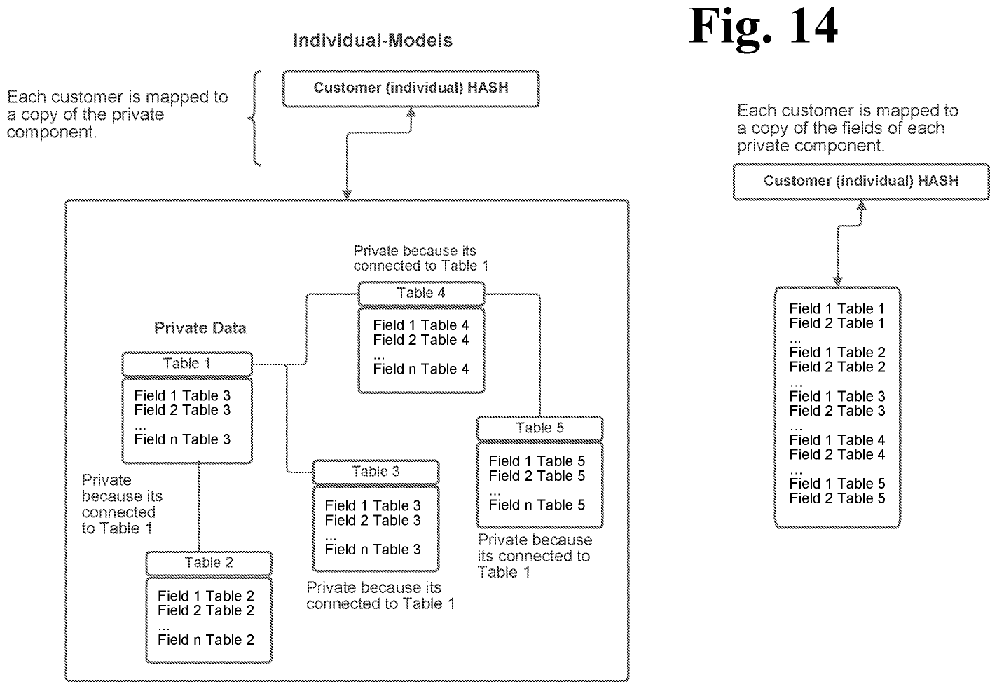

Turning to FIG. 14, an embodiment of the present invention is illustrated.

Step 1 Suppose the data for ‘person X’ is located in table or collection ‘Y’. Further suppose that ‘K’ is either a primary key for table or collection ‘Y’ or a set of fields that identify a unique individual similar to a primary key. The first step is to hash the primary key ‘K’ and store ‘K’ and ‘Hash(K)’ in a database on the client side.

Step 2 Next identify the connected components of the metamodel. A connected component is a subset of the vertices in which there is a path between any pair of vertices. A connected component in the context of a Mₚ means that every field in every table is revealed in that component and further, starting at any table in the component it is easy to discover the ‘private’ information using just database operations.

Step 3. Finally each individual is connected to all of the connected components in which their private data appears.

The database is a combination of the metadata stored as a metamodel data graph on the ‘privacy trusted data store’ and all of the individuals' tracking data also stored on the ‘privacy trusted data store’. Changes in the client side databases, consumer requests leading to leading to changes in individual's tracking data and changes to the an individual's data all trigger operations on the privacy trusted data store.

### Operations on the ‘Private Trusted Data Stores’

Operation 1—Sharding and Replication

Sharding and replication are operations on databases that do not alter the structure of the data but alter the location of the data.

Shards—Each database handles shards differently but all database collections and tables can be stored in shards. Given a table or collection R=R(F₁, . . . , Fₚ) sharding decomposes R into shards R_{S}_{₁}, . . . R_{S}_{_{M}} such that ∪{R_{S}_{ⱼ}}_{j∈M}=R.

Replicants—Each database handles replicants different but most databases allow replication of databases. Given a table or collection R=R(F₁, . . . , F_{P}) replication creates relations R_{R}_{₁}, . . . , R_{R}_{_{M}} such that R_{R}_{₁}==R_{R}_{_{M}}=R.

No updates need to be done here for the MVP.

Operation 2—Change to the Database's Metadata

A change to the structure and number of database schemas triggers a a remapping of the database and the tracking data. The remapping happens in several steps:

Step 1—The first step is to calculate the the new privacy relations data graph.

We are given the old privacy relations data graph G_{O}=(V_{O}, E_{O}) and we calculate the new privacy relations data graph G_{N}=(V_{N}, E_{N}). The difference between G_{O} and G_{N} can be analysed as the delta ΔG=(ΔV, ΔE). Suppose we write the set ΔV=(V_{O}−V_{D}−V_{OC}) ∩V_{NC} ∩V_{U} where V_{D} is the set of relations deleted, V_{OC} is the set of relations that will be changed but without the changes applied, V_{NC} is the set of relations with the changes applied, and V_{U} is the set of relations added, and ΔE is recalculated.

Step 2—The second step is to recalculate all of the individuals' subgraphs from the modified data graph G_{N} (see step 1 above).

Operation 3—Change to an Individual's Privacy Data

A change to an individual's privacy data takes effect as follows.

Step 1—Find their multi hash in the client side lookup table for the individual's private key.

Step 2—Use the hash to find the individual's privacy data subgraph of G.

Step 3—Traverse the data graph and change the appropriate FIELDs (this operation probably does not require user interaction but can be handled via the dashboard).

Operation 4—Change to an Individual's Data

A change to an individual's data does not affect the metadata mapping.

Operation 5—A Request to Show Data Stored and 12 Month Lookback

A request to show data occurs as follows:

Step 1—Find their multi hash in the client side lookup table for the individual's private key.

Step 2—Use the hash to find the individual's privacy data subgraph of G.

Step 3—Return the privacy data subgraph of G.

Operation 6—Deletion of an Individual's Data

There are two possible cases for the deletion of data:

Case 1—An individual leaves the business and requires that all of their data is to be deleted.

Case 2—An individual asks that specific data items be deleted.

### Computer Implementation

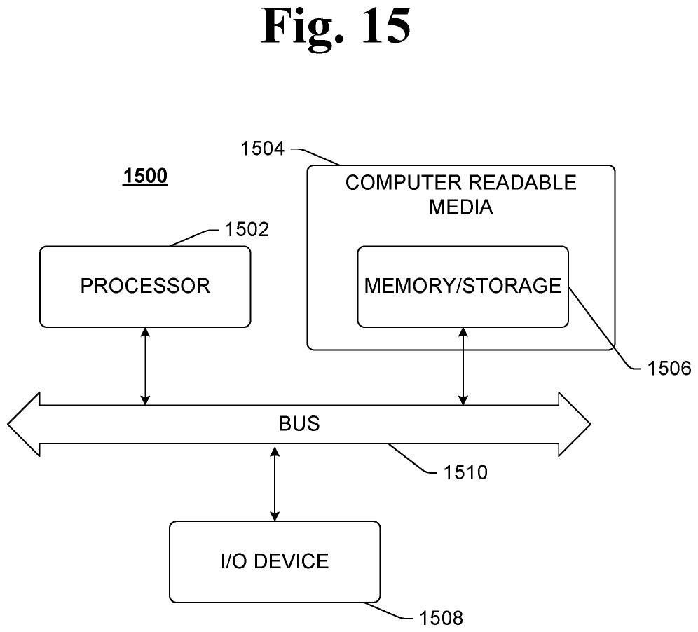

FIG. 15 illustrates an example computing device 1500 that can be configured to implement embodiments in accordance with one or more embodiments. Computing device 1500 can implement any of the techniques and processes discussed herein.

Computing device 1500 includes one or more processors or processing units 1502, one or more computer readable media 1504 which can include one or more memory and/or storage components 1506, one or more input/output (I/O) devices 1508, and a bus 1510 that allows the various components and devices to communicate with one another. Computer readable media 1504 and/or I/O device(s) 1508 can be included as part of, or alternatively may be coupled to, computing device 1500. Bus 1510 represents one or more of any of several types of bus structures, including a memory bus or memory controller, a peripheral bus, an accelerated data graphics port, and a processor or local bus using any of a variety of bus architectures. Bus 1510 can include wired and/or wireless buses.

Memory/storage component 1506 represents one or more computer storage media. Component 1506 can include volatile media (such as random access memory (RAM)) and/or nonvolatile media (such as read only memory (ROM), Flash memory, optical disks, magnetic disks, and so forth). Component 1506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by processor 1502. It is to be appreciated that different instructions can be stored in different components of computing device 1500, such as in processor 1502, in various cache memories of processor 1502, in other cache memories of device 1500 (not shown), on other computer readable media, and so forth. Additionally, it is to be appreciated that the location where instructions are stored in computing device 1500 can change over time.

One or more input/output devices 1508 allow a User to enter commands and information to computing device 1500, and also allows information to be presented to the User and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media.

“Computer readable media” can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Additionally, it should be noted that in one or more embodiments the techniques discussed herein can be implemented in hardware. For example, one or more logic circuits, application-specific integrated circuits (ASICs), programmable logic devices (PLDs), and so forth can be created and/or configured to implement the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### CLOSING DISCUSSION

Unless otherwise indicated, all numbers expressing quantities used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by embodiments. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of embodiments are approximations, the numerical values set forth in the specific examples are reported as precisely as possible. If specific results of any tests are reported in the technical disclosure, any numerical value inherently can contain certain errors necessarily resulting from the standard deviation found in the respective testing measurements.

The terms “a” and “an” and “the” and similar referents used in the context of describing embodiments (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”, “in the case”, “by way of example”) provided herein is intended merely to better illuminate embodiments and does not pose a limitation on the scope of the embodiments otherwise claimed. No language in the specification should be construed as indicating any non-claimed element essential to the practice of embodiments.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Preferred embodiments are described herein, including the best mode known to the inventors for carrying out embodiments. Of course, variations on those preferred embodiments will become apparent to those of ordinary skill in the art upon reading the foregoing description. The inventor(s) expects skilled artisans to employ such variations as appropriate, and the inventor(s) intend for embodiments to be practiced otherwise than specifically described herein. Accordingly, embodiments include all modifications and equivalents of the subject matter recited in the claims appended hereto as permitted by applicable law. Moreover, any combination of the above-described elements in all possible variations thereof is encompassed by embodiments unless otherwise indicated herein or otherwise clearly contradicted by context.

Furthermore, if any references have been made to patents and printed publications in this specification, then each of the above cited references and printed publications, if any, are herein individually incorporated by reference in their entirety. In closing, it is to be understood that the embodiments disclosed herein are illustrative of the principles of embodiments. Other modifications that may be employed are within the scope of embodiments. Thus, by way of example, but not of limitation, alternative configurations of the present embodiments may be utilized in accordance with the teachings herein. Accordingly, embodiments are not limited to that precisely as shown and described.

### Literal Recitation

A computer-implemented method for management of personal information is disclosed, comprising:

deploying a distributed ledger;

extracting metadata from one or more databases containing personal information, wherein the metadata represents a type and a source of the personal information;

creating a data graph from the extracted metadata, wherein one or more nodes of the data graph each represent one of a type of personal information and a source of personal information, and wherein one or more edges of the data graph represent relationships of the types of personal information to the sources of personal information;

creating a metamodel based on one or more nodes and one or more edges of the data graph and corresponding to a person;

creating a primary key associated with the metamodel; and,

storing the metamodel on the distributed ledger and indexed through the primary key.

The distributed ledger may be a blockchain.

The step of extracting metadata from one or more databases may be performed by executing an application on a platform that hosts the one or more databases.

The metadata may represent the type and the source of the personal information and omits the personal information.

The metadata may point to where personal information is stored, and personal information is underivable solely from the metadata.

The metamodel may point to where personal information is located, and personal information cannot be derived solely from the metamodel.

The data graph may represent the type and the source of the personal information and is void of the personal information.

The data graph can point to where personal information is located, and personal information cannot be derived solely from the data graph.

The storing of the metamodel on the distributed ledger may provide an auditable, transparent ledger of activities of the metamodel.

The storing of the metamodel on the distributed ledger may provide that access to the metamodel is limited based on the primary key for the metamodel.

The method may further comprise the step of creating a report of interactions and activities on the metamodel.

A method for notification for compliance with personal information laws is disclosed, comprising:

providing one or more metamodels stored on a distributed ledger;

receiving a catalyst to initiate notification to a person;

determining a primary key for the person;

if a metamodel indexed by the primary key is present on the distributed ledger, retrieving the metamodel from the one or more metamodels stored on the distributed ledger;

if a metamodel indexed by the primary key is not present on the distributed ledger, creating a new metamodel indexed by the primary key to be stored on the distributed ledger;

sending a notification pursuant to the catalyst;

updating the person's metamodel to include indication of the notification; and,

storing the person's metamodel on the distributed ledger.

The distributed ledger may be a blockchain.

The request may be to opt out of data disclosure.

The request may be to provide a data disclosure report.

The catalyst may be a request from the person.

The catalyst may be a calendar event.

The catalyst may be an updated agreement.

The step of retrieving the person's personal information may be from a source database, the source database may be identified in the person's metamodel.

A method for automation and management of personal information for compliance with a regulatory framework is disclosed, comprising:

deploying a blockchain;

extracting metadata from one or more databases containing personal information, wherein the metadata represents a type and a source of the personal information and does not contain the personal information itself;

creating a data graph from the extracted metadata, wherein one or more vertices of the data graph each represent one of a type of personal information and a source of personal information, and wherein one or more edges represent relationships between the one of a type of personal information to the source of personal information;

creating a metamodel by identifying one or more vertices and one or more edges of the data graph that correspond to a person;

creating a primary key associated with the metamodel; and,

storing the metamodel on the blockchain and indexed based on the primary key;

receiving a catalyst to initiate notification to the person;

determining an unhashed primary key for the person;

creating a hashed primary key from the unhashed primary key;

if a metamodel representing the hashed primary key is present on the blockchain, retrieving the person's metamodel from the one or more metamodels stored on the blockchain;

if a metamodel representing the primary key is not present on the blockchain, creating a new metamodel for the person for storage on the blockchain;

sending a notification pursuant to the catalyst;

updating the person's metamodel with the notification;

storing the person's metamodel on the blockchain; and,

creating a report of interactions and activities on the metamodel;

wherein the step of extracting metadata from one or more databases is performed by executing an application running on the platform that hosts the one or more databases;

wherein the blockchain provides that the data can only be accessed through a hashed primary key, and wherein the blockchain does not contain personal information, but only stores one or more metamodels and metadata;

wherein the metamodel and metadata can point to where personal information exists, but it is not possible to derive personal information solely from the metamodel nor metadata;

wherein the data graph represents the type and source of the personal information, but does not contain the personal information itself; and,

wherein the storing of the metamodel on the blockchain provides an auditable, transparent ledger of activities of the metamodel.

What is claimed is:

1. A computer-implemented method for management of personal information, comprising:
deploying a distributed ledger;
extracting metadata from one or more databases containing personal information, wherein the metadata represents a type and a source of the personal information;
creating a data graph from the extracted metadata, wherein one or more nodes of the data graph each represent one of a type of personal information and a source of personal information, and wherein one or more edges of the data graph represent relationships of the types of personal information to the sources of personal information;
creating a metamodel based on one or more nodes and one or more edges of the data graph and corresponding to a person;
creating a primary key associated with the metamodel; and,
storing the metamodel on the distributed ledger and indexed through the primary key.

2. The method of claim 1 wherein the distributed ledger is a blockchain.

3. The method of claim 1 wherein the step of extracting metadata from one or more databases is performed by executing an application on a platform that hosts the one or more databases.

4. The method of claim 1 wherein the metadata represents the type and the source of the personal information and omits the personal information.

5. The method of claim 1 wherein the metadata can point to where personal information is stored, and personal information is underivable solely from the metadata.

6. The method of claim 1 wherein the metamodel points to where personal information is located, and personal information cannot be derived solely from the metamodel.

7. The method of claim 1 wherein the data graph represents the type and the source of the personal information and is void of the personal information.

8. The method of claim 1 wherein the data graph can point to where personal information is located, and personal information cannot be derived solely from the data graph.

9. The method of claim 1 wherein the storing of the metamodel on the distributed ledger provides an auditable, transparent ledger of activities of the metamodel.

10. The method of claim 1 wherein the storing of the metamodel on the distributed ledger provides that access to the metamodel is limited based on the primary key for the metamodel.

11. The method of claim 1 further comprising the step of creating a report of interactions and activities on the metamodel.

12. A method for notification for compliance with personal information laws, comprising:
providing one or more metamodels stored on a distributed ledger;
receiving a catalyst to initiate notification to a person;
determining a primary key for the person;
if a metamodel indexed by the primary key is present on the distributed ledger, retrieving the metamodel from the one or more metamodels stored on the distributed ledger;
if a metamodel indexed by the primary key is not present on the distributed ledger, creating a new metamodel indexed by the primary key to be stored on the distributed ledger;
sending a notification pursuant to the catalyst;
updating the person's metamodel to include indication of the notification; and,
storing the person's metamodel on the distributed ledger.

13. The method of claim 12 wherein the distributed ledger is a blockchain.

14. The method of claim 13 wherein the request is to opt out of data disclosure.

15. The method of claim 13 wherein the request is to provide a data disclosure report.

16. The method of claim 12 wherein the catalyst is a request from the person.

17. The method of claim 12 wherein the catalyst is a calendar event.

18. The method of claim 12 wherein the catalyst is an updated agreement.

19. The method of claim 12 further comprising the step of retrieving the person's personal information from a source database, the source database identified in the person's metamodel.

20. A method for automation and management of personal information for compliance with a regulatory framework, comprising:
deploying a blockchain;
extracting metadata from one or more databases containing personal information, wherein the metadata represents a type and a source of the personal information and does not contain the personal information itself;
creating a data graph from the extracted metadata, wherein one or more vertices of the data graph each represent one of a type of personal information and a source of personal information, and wherein one or more edges represent relationships between the one of a type of personal information to the source of personal information;
creating a metamodel by identifying one or more vertices and one or more edges of the data graph that correspond to a person;
creating a primary key associated with the metamodel; and,
storing the metamodel on the blockchain and indexed based on the primary key;
receiving a catalyst to initiate notification to the person;
determining an unhashed primary key for the person;
creating a hashed primary key from the unhashed primary key;
if a metamodel representing the hashed primary key is present on the blockchain, retrieving the person's metamodel from the one or more metamodels stored on the blockchain;
if a metamodel representing the primary key is not present on the blockchain, creating a new metamodel for the person for storage on the blockchain;
sending a notification pursuant to the catalyst;
updating the person's metamodel with the notification;
storing the person's metamodel on the blockchain; and,
creating a report of interactions and activities on the metamodel;
wherein the step of extracting metadata from one or more databases is performed by executing an application running on the platform that hosts the one or more databases;
wherein the blockchain provides that the data can only be accessed through a hashed primary key, and wherein the blockchain does not contain personal information, but only stores one or more metamodels and metadata;
wherein the metamodel and metadata can point to where personal information exists, but it is not possible to derive personal information solely from the metamodel nor metadata;
wherein the data graph represents the type and source of the personal information, but does not contain the personal information itself; and,
wherein the storing of the metamodel on the blockchain provides an auditable, transparent ledger of activities of the metamodel.
